(19) United States
(12) Patent Application Publication
(10) Pub. No.: US 2014/0362151 A1
(43) Pub. Date: Dec. 11, 2014

(54) RADIATION-CURABLE INK FOR INK JET RECORDING, RECORD MADE USING THE SAME, AND INK JET RECORDING METHOD USING THE SAME

(71) Applicant: Seiko Epson Corporation, Tokyo (JP)

(72) Inventors: Jun Ito, Shimosuwa-machi (JP); Hiroki Nakane, Matsumoto-shi (JP)

(73) Assignee: Seiko Epson Corporation, Tokyo (JP)

(21) Appl. No.: 14/275,269

(22) Filed: May 12, 2014

Related U.S. Application Data
(62) Division of application No. 13/354,606, filed on Jan. 20, 2012, now abandoned.

(30) Foreign Application Priority Data
Jan. 21, 2011 (JP) 2011-010813
Mar. 15, 2011 (JP) 2011-056266

(51) Int. Cl. C09D 133/08; B41J 11/00; C09D 11/30

(52) U.S. Cl. CPC C09D 133/08; C09D 11/30; B41J 11/002
USPC 347/102

(57) ABSTRACT

A radiation-curable ink for ink jet recording contains N-vinylcaprolactam. The N-vinylcaprolactam content is in a range of 5% by mass to 20% by mass, inclusive, relative to the total mass of the ink. The ink is for the purpose of making a marking on a recording medium, and the recording medium is a package substrate or a semiconductor substrate. The ink is applied to the package substrate or the semiconductor substrate, exposed to radiation, and then subjected to a heat treatment at a temperature in a range of 150° C. to 200° C., inclusive.

### CROSS REFERENCES TO RELATED APPLICATION

The entire disclosure of Japanese Patent Application No.: 2011-010813, filed Jan. 21, 2011 and 2011-056266, filed Mar. 15, 2011 are expressly incorporated by reference herein.

### BACKGROUND

1. Technical Field

The present invention relates to a radiation-curable ink for ink jet recording, a record made using this ink, and an ink jet recording method using this ink.

2. Related Art

Formation of images from image data signals and recording the images on recording media can be performed by various methods. In particular, ink jet recording, in which an affordable apparatus forms images directly on a recording medium by ejecting ink onto required areas only, is superior in the efficiency of ink use and thus saves on running costs.

Recent ink jet recording methods make it possible to form images favorable in terms of waterproofness, resistance to solvents, and rubfastness on the surface of a recording medium by including the use of a radiation-curable ink for ink jet recording, which is an ink that is cured upon exposure to radiation.

Meanwhile, sealed semiconductor chips (integrated circuit [IC] chips) have recently been used as electronic components (IC packages) in various kinds of devices, and such electronic components usually have markings such as letters, symbols, and logos. Thus, printing techniques for making markings suitable for electronic components are in demand.

For example, JP-A-11-274335 discloses a method for making markings on electronic components, in which ink is ejected onto an electronic component such as an IC chip, and the ink is then fixed to the electronic component by irradiating the ink with ultraviolet light. Also, JP-A-2000-332376 discloses a method for making markings on semiconductor devices, in which ink is ejected onto a substrate as a matrix of bare chips and prints information, such as the lot number, on unnecessary edge regions of the substrate.

JP-A-2006-21479 discloses an ink jet recording method for the manufacturing of printed circuit boards, in which an ink containing titanium dioxide is cured to have a maximum thickness in a range of 10 to 30 μm by ultraviolet (UV) irradiation, with the integrated intensity and the illuminance of the UV light adjusted to fall within particular ranges. Also, JP-T-2007-527459 discloses an ink jet printing method, in which a UV-curable ink containing a coloring agent, a photopolymerization initiator, and an epoxy reagent is ejected from an ink jet printer onto a printed circuit board to make a marking and the marking is then exposed to UV light no later than 2 seconds after it is made.

Japanese Utility Model No. 2,539,839 discloses a molded IC package having a coating thereon and a marking made on the coating. JP-A-2003-273172 discloses a marking method in which a wafer having multiple IC chips is marked only on defective IC chips.

However, these techniques are all lacking in at least one of the rubfastness, adhesiveness, and alcohol resistance of the ink. Known marking methods are disadvantageous in that they cannot be easily applied to precise electronic components.

### SUMMARY

An advantage of some aspects of the invention is that they provide a radiation-curable ink for ink jet recording that has excellent rubfastness, adhesiveness, and alcohol resistance, a record made using this ink, and an ink jet recording method using this ink.

The inventors have conducted extensive research to solve the above problem. In known methods for marking electronic components, the cured products of ink made on electronic components methods are lacking in at least one of rubfastness, adhesiveness, and alcohol resistance and are all impractical.

Under these circumstances, the inventors found the following fact: When a curable ink contains a particular amount of N-vinylcaprolactam and the cured ink is then heated under particular conditions, the obtained product is quite excellent in terms of rubfastness, adhesiveness, and alcohol resistance, and it allows for a fully practical method for making markings on electronic components.

The inventors further discovered the following: A radiation-curable ink for ink jet recording (hereinafter also referred to simply as ink) containing a particular amount of N-vinylcaprolactam, when cured and heated under particular conditions on a package substrate or a semiconductor substrate for electronic components, provides a favorable marking on the substrate, and the cured product shows excellent properties in all of rubfastness, alcohol resistance, and adhesiveness to the substrate. Based on these findings, an aspect of the invention was completed.

More specifically, this first aspect of the invention includes the following.

1. A radiation-curable ink for ink jet recording containing N-vinylcaprolactam. The N-vinylcaprolactam content is in a range of 5% by mass to 20% by mass, inclusive, relative to the total mass of the ink. The ink is for the purpose of making a marking on a recording medium, and the recording medium is a package substrate or a semiconductor substrate. The ink is applied to the package substrate or the semiconductor substrate, exposed to radiation, and then subjected to a heat treatment at a temperature in a range of 150° C. to 200° C., inclusive.

2. The radiation-curable ink for ink jet recording according to 1, further containing a polyfunctional acrylate. The polyfunctional acrylate content is in a range of 5% by mass to 20% by mass, inclusive, relative to the total mass of the ink.

3. The radiation-curable ink for ink jet recording according to 2, wherein the polyfunctional acrylate has a pentaerythritol structure.

4. The radiation-curable ink for ink jet recording according to any one of 1 to 3, wherein the heat treatment at a temperature in a range of 150° C. to 200° C., inclusive, is performed for a period of time in a range of 10 minutes to 75 minutes, inclusive.

5. The radiation-curable ink for ink jet recording according to any one of 1 to 4, wherein the radiation has an emission peak wavelength in a range of 350 nm to 405 nm, inclusive, and is emitted to the ink until an irradiation of at least 100 mJ/cm² is reached.

6. A record composed of a recording medium and a cured product of the radiation-curable ink for ink jet recording according to any one of 1 to 5. The recording medium is a package substrate or a semiconductor substrate, and the package substrate or the semiconductor substrate has a marking made by the cured product of the ink.

7. An ink jet recording method including ejecting a radiation-curable ink for ink jet recording onto a package substrate or a semiconductor substrate, curing the ejected ink, and heating the cured ink. The radiation-curable ink for ink jet recording contains N-vinylcaprolactam, and the N-vinylcaprolactam content is in a range of 5% by mass to 20% by mass, inclusive, relative to the total mass of the ink. The ejected ink is cured by exposure to radiation, and the cured ink is heated at a temperature in a range of 150° C. to 200° C., inclusive.

Furthermore, the inventors, under the circumstances described above, also found the following fact: When a curable ink contains N-vinylcaprolactam and a polyfunctional (meth)acrylate having a pentaerythritol structure, the cured product of the ink is quite excellent in terms of rubfastness, adhesiveness, and alcohol resistance, and it allows for a fully practical method for making markings on electronic components.

The inventors further discovered the following: A radiation-curable ink for ink jet recording (as mentioned above, also referred to simply as ink) containing particular amounts of N-vinylcaprolactam and a polyfunctional (meth)acrylate having a pentaerythritol structure, when cured on a package substrate or a semiconductor substrate for electronic components, provides a favorable marking on the substrate, and the cured product shows excellent properties in all of rubfastness, alcohol resistance, and adhesiveness to the substrate. Based on these findings, another aspect of the invention was completed.

More specifically, this second aspect of the invention includes the following.

1. A radiation-curable ink for ink jet recording containing N-vinylcaprolactam and a polyfunctional (meth)acrylate. The N-vinylcaprolactam content is in a range of 5% by mass to 20% by mass, inclusive, and the polyfunctional (meth)acrylate content is in a range of 5% by mass to 20% by mass, inclusive, both relative to the total mass of the ink.

2. The radiation-curable ink for ink jet recording according to 1, wherein the polyfunctional (meth)acrylate has a pentaerythritol structure.

3. The radiation-curable ink for ink jet recording according to any one of 1 to 2, wherein a recording medium to which the ink is applied is a package substrate or a semiconductor substrate.

4. A record composed of a recording medium and a cured product of the radiation-curable ink for ink jet recording according to any one of 1 to 3. The recording medium is a package substrate or a semiconductor substrate, and the package substrate or the semiconductor substrate has a marking made by the cured product of the ink.

5. An ink jet recording method including ejecting the radiation-curable ink for ink jet recording according to 1 onto a package substrate or a semiconductor substrate and curing the ejected ink. The ejected ink is cured by exposure to an active radiation, and this active radiation has an emission peak wavelength in a range of 350 nm to 400 nm, inclusive.

### DESCRIPTION OF EXEMPLARY EMBODIMENTS

The following details some embodiments of the first aspect of the invention. These embodiments do not limit this aspect of the invention; various modifications can be made without departing from the spirit of this aspect of the invention.

The package substrate as used herein represents a protective substrate on which an electronic element such as a semiconductor chip is sealed. The semiconductor substrate as used herein includes not only electronic elements such as semiconductor chips but also wafers that can be directly used as substrates. Hereinafter, package substrates and semiconductor substrates are sometimes collectively referred to as package/semiconductor substrates. Also, the record as used herein is a record composed of a package substrate or a semiconductor substrate and a cured product of ink formed on the substrate. The cured product as used herein includes all cured forms of ink such as cured film and coating.

Curing as used herein represents a process including exposure of an ink containing a polymerizable compound to radiation, polymerization of the polymerizable compound, and the resultant hardening of the ink. Curable means that the ink is cured in response to light. Adhesiveness is how difficult a coating is to remove from its substrate, and, in Examples section, it specifically means the adhesiveness of a cured product having a grid pattern cut to reach the substrate such as a package/semiconductor substrate. Rubfastness is how difficult a cured product is to remove from a package/semiconductor substrate by scratching. Alcohol resistance also represents how difficult a cured product is to remove from a package/semiconductor substrate by scratching, but is evaluated after the record with the cured product is immersed in an isopropyl alcohol (IPA) solution. Ejection stability is a property of an ink jet apparatus that allows the apparatus to always stably eject droplets of ink from its nozzles with no clogging.

The (meth)acrylate as used herein refers to an acrylate and/or the corresponding methacrylate, and (meth)acrylic refers to an acrylic group and/or the corresponding methacrylic group.

### Radiation-Curable Ink for Ink Jet Recording

The radiation-curable ink for ink jet recording according to an embodiment of this aspect of the invention contains N-vinylcaprolactam, and the N-vinylcaprolactam content of the ink is in a range of 5% by mass to 20% by mass, inclusive, relative to the total mass of the ink (100% by mass). The ink is cured by exposure to radiation, is subjected to a heat treatment at a temperature in a range of 150° C. to 200° C., inclusive, and thereby forms a cured product. The ink can be suitably used to record some information on a package substrate or a semiconductor substrate as a recording medium.

The following describes the essential ingredients of the radiation-curable ink for ink jet recording according to this embodiment and additives that may be contained in the ink as necessary.

### Polymerizable Compound

The radiation-curable ink for ink jet recording according to this embodiment contains a polymerizable compound. When exposed to light, the polymerizable compound is polymerized by the action of the photopolymerization initiator, described later, and thereby cures the printed portions of the ink.

### N-Vinylcaprolactam

In this embodiment, N-vinylcaprolactam is used as the polymerizable compound. The ink, containing N-vinylcaprolactam as the polymerizable compound, shows good curability, adhesiveness, rubfastness, and alcohol resistance.

The N-vinylcaprolactam content is in a range of 5% by mass to 20% by mass, inclusive, and preferably 9% by mass to 15% by mass, inclusive, relative to the total mass of the ink (100% by mass). When the N-vinylcaprolactam content is in this range, the ink has excellent adhesiveness, rubfastness, and alcohol resistance.

### Compound Having Both Vinyl and (Meth)Acrylic Groups in its Molecule

In this embodiment, a compound of general formula (I) (hereinafter referred to as monomer A) may be used as another polymerizable compound.

CH₂═CR¹—COOR²—O—CH═CH—R³ (I)

(where R¹ is a hydrogen atom or a methyl group, R² is a divalent organic residue having 2 to 20 carbon atoms [a C₂ to C₂₀ divalent organic residue], and R³ is a hydrogen atom or a C₁ to C₁₁ monovalent organic residue.)

Monomer A is a compound having both vinyl and (meth)acrylic groups in its molecule, or in other words a vinyl-ether-containing (meth)acrylate.

The ink, when containing monomer A, can have its curability and other characteristics further improved.

In general formula (I), preferred examples of R², a divalent organic residue, are linear, branched, or cyclic C₂ to C₂₀ alkylene groups, C₂ to C₂₀ alkylene groups having an oxygen atom derived from an internal ether or ester bond, and substituted or unsubstituted C₆ to C₁₁ divalent aromatic groups. Among these, particularly preferred ones are C₂ to C₆ alkylene groups such as ethylene, n-propylene, isopropylene, and butylene groups and C₂ to C₉ alkylene groups having an oxygen atom derived from an internal ether bond such as oxyethylene, oxy-n-propylene, oxyisopropylene, and oxybutylene groups.

In general formula (I), preferred examples of R³, a C₁ to C₁₁ monovalent organic residue, are linear, branched, or cyclic C₁ to C₁₀ alkyl groups and substituted or unsubstituted C₆ to C₁₁ aromatic groups. Among these, particularly preferred ones are methyl and ethyl groups (C₁ and C₂ alkyl groups) and C₆ to C₈ aromatic groups such as phenyl and benzyl groups.

Possible substituents of these organic residues are divided into those having carbon atoms and those having no carbon atoms. When any substituent having carbon atoms is used, the carbon atoms of this substituent should be included in the number of the carbon atoms of the organic residue. Examples of suitable substituents having carbon atoms include, but are not limited to, carboxy and alkoxy groups. Examples of suitable substituents having no carbon atoms include, but are not limited to, hydroxy and halo groups.

Specific examples of monomer A of general formula (I) include, but are not limited to, the following: 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethyl propyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethyl cyclohexyl methyl (meth)acrylate, 3-vinyloxymethyl cyclohexyl methyl (meth)acrylate, 2-vinyloxymethyl cyclohexyl methyl (meth)acrylate, p-vinyloxymethyl phenyl methyl (meth)acrylate, m-vinyloxymethyl phenyl methyl (meth)acrylate, o-vinyloxymethyl phenyl methyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

Among these, preferred ones are 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 4-vinyloxycyclohexyl (meth)acrylate, 5-vinyloxypentyl (meth)acrylate, 6-vinyloxyhexyl (meth)acrylate, 4-vinyloxymethyl cyclohexyl methyl (meth)acrylate, p-vinyloxymethyl phenyl methyl (meth)acrylate, 2-(vinyloxyethoxy)ethyl (meth)acrylate, 2-(vinyloxyethoxyethoxy)ethyl (meth)acrylate, and 2-(vinyloxyethoxyethoxyethoxy)ethyl (meth)acrylate.

In particular, 2-(vinyloxyethoxy)ethyl (meth)acrylate, which has a low viscosity, a high flash point, and better curability than others, is more preferred than others, and 2-(vinyloxyethoxy)ethyl acrylate, which additionally has reduced odor, mildness to the skin, and excellent reactivity and adhesiveness, is even more preferred.

Examples of 2-(vinyloxyethoxy)ethyl (meth)acrylate include 2-(2-vinyloxyethoxy)ethyl (meth)acrylate and 2-(1-vinyloxyethoxy)ethyl (meth)acrylate, and examples of 2-(vinyloxyethoxy)ethyl acrylate include 2-(2-vinyloxyethoxy)ethyl acrylate and 2-(1-vinyloxyethoxy)ethyl acrylate.

Monomer A may be one of or a combination of two or more kinds of these compounds.

The content of monomer A is preferably in a range of 20% by mass to 50% by mass, inclusive, relative to the total mass of the ink (100% by mass). When the content of monomer A is in this range, the ink has its adhesiveness, rubfastness, and alcohol resistance further improved.

Processes for preparing monomer A of general formula (I) include, but are not limited to, the following: esterifying a (meth)acrylic acid and a hydroxy-group-containing vinyl ether (process B), esterifying a (meth)acrylic acid halide and a hydroxy-group-containing vinyl ether (process C), esterifying a (meth)acrylic acid anhydride and a hydroxy-group-containing vinyl ether (process D), transesterifying a (meth)acrylate and a hydroxy-group-containing vinyl ether (process E), esterifying a (meth)acrylic acid and a halogen-containing vinyl ether (process F), esterifying a (meth)acrylic acid-alkali (or alkaline-earth) metal salt and a halogen-containing vinyl ether (process G), transvinylating a hydroxy-group-containing (meth)acrylate and a vinyl carboxylate (process H), and transetherifying a hydroxy-group-containing (meth)acrylate and an alkyl vinyl ether (process I).

Among these, process E is preferred because monomer A prepared by this process enhances the advantages of this embodiment more than those made by the other processes can.

### Other Polymerizable Compounds

Examples of suitable polymerizable compounds other than the above (hereinafter referred to as additional polymerizable compounds) include various kinds of known monomers and oligomers including monofunctional, bifunctional, trifunctional, and other polyfunctional ones. Examples of suitable monomers include unsaturated carboxylic acids such as (meth)acrylic acid, itaconic acid, corotonic acid, isocrotonic acid, and maleic acid and their salts, esters, urethanes, amides, and anhydrides, acrylonitrile, styrene, various kinds of unsaturated polyesters, unsaturated polyethers, unsaturated polyamides, and unsaturated urethanes. Examples of suitable oligomers include linear acrylic oligomers and other oligomers derived from the monomers listed above, epoxy (meth)acrylates, oxetane (meth)acrylates, aliphatic urethane (meth)acrylates, aromatic urethane (meth)acrylates, and polyester (meth)acrylates.

Furthermore, N-vinyl compounds other than N-vinylcaprolactam may be contained as additional monofunctional or polyfunctional monomers. Examples of suitable N-vinyl compounds include N-vinylformamide, N-vinylcarbazole, N-vinylacetamide, N-vinylpyrrolidone, acryloylmorpholine, and their derivatives.

For use as additional polymerizable compounds, (meth)acrylic acid esters ([meth]acrylates) are preferred, polyfunctional (meth)acrylates ([meth]acrylates having two or more functional groups) are more preferred, and polyfunctional acrylates are even more preferred. The ink according to this embodiment, when containing a polyfunctional acrylate as an additional polymerizable compound in addition to the particular amount of N-vinylcaprolactam, has its adhesiveness, rubfastness, and alcohol resistance further improved.

Examples of monofunctional (meth)acrylates suitable for use as additional polymerizable compounds include the following: isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethyl hexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylate, t-butyl cyclohexyl (meth)acrylate, dicyclopentanyl (meth)acrylate, and dicyclopentenyloxyethyl (meth)acrylate.

Examples of polyfunctional (meth)acrylates suitable for use as additional polymerizable compounds include the following: bifunctional (meth)acrylates including triethyleneglycol di(meth)acrylate, tetraethyleneglycol di(meth)acrylate, polyethyleneglycol di(meth)acrylate, tripropyleneglycol di(meth)acrylate, polypropyleneglycol di(meth)acrylate, 1,4-butanediol di(meth)acrylate, 1,6-hexanediol di(meth)acrylate, 1,9-nonanediol di(meth)acrylate, neopentylglycol di(meth)acrylate, dimethylol-tricyclodecane di(meth)acrylate, bisphenol A di(meth)acrylate, hydroxypivalic acid neopentylglycol di(meth)acrylate, and polytetramethyleneglycol di(meth)acrylate; and trifunctional and other polyfunctional (meth)acrylates such as trimethylolpropane tri(meth)acrylate, glycerol propoxy tri(meth)acrylate, caprolactone-modified trimethylolpropane tri(meth)acrylate, ditrimethylolpropane tetra(meth)acrylate, sorbitol penta(meth)acrylate, (meth)acrylates having a pentaerythritol structure, e.g., pentaerythritol tri(meth)acrylate, pentaerythritol tetra(meth)acrylate, and pentaerythritol ethoxy tetra(meth)acrylate, (meth)acrylates having a dipentaerythritol structure, e.g., dipentaerythritol hexa(meth)acrylate, caprolactam-modified dipentaerythritol hexa(meth)acrylate, dipentaerythritol penta(meth)acrylate, and caprolactone-modified dipentaerythritol hexa(meth)acrylate, (meth)acrylates having a tripentaerythritol structure, e.g., propionic-acid-modified tripentaerythritol penta(meth)acrylate, tripentaerythritol hexa(meth)acrylate, tripentaerythritol hepta(meth)acrylate, and tripentaerythritol octa(meth)acrylate, (meth)acrylates having a tetrapentaerythritol structure, e.g., tetrapentaerythritol penta(meth)acrylate, tetrapentaerythritol hexa(meth)acrylate, tetrapentaerythritol hepta(meth)acrylate, tetrapentaerythritol octa(meth)acrylate, tetrapentaerythritol nona(meth)acrylate, and tetrapentaerythritol deca(meth)acrylate, (meth)acrylates having a pentapentaerythritol structure, e.g., pentapentaerythritol undeca(meth)acrylate, pentapentaerythritol dodeca(meth)acrylate, and their ethylene oxide (EO) and/or propylene oxide (PO) adducts.

Among others, polyfunctional (meth)acrylates are preferred for use as additional polymerizable compounds, as mentioned above. Among polyfunctional (meth)acrylates, polyfunctional (meth)acrylates having a pentaerythritol structure such as those listed above are preferred, and polyfunctional acrylates having a pentaerythritol structure are more preferred. When any polyfunctional (meth)acrylate having a pentaerythritol structure is used, the use of pentaerythritol tri(meth)acrylate and/or pentaerythritol tetra(meth)acrylate is preferred, and the use of pentaerythritol triacrylate and/or pentaerythritol tetraacrylate is more preferred. Polyfunctional (meth)acrylates give the ink not only further improved adhesiveness, rubfastness, and alcohol resistance but also a reduced viscosity and an increased cross-linking density.

In addition, when any monofunctional (meth)acrylate is used, the use of phenoxyethyl (meth)acrylate and/or isobornyl (meth)acrylate is preferred, the use of phenoxyethyl (meth)acrylate is more preferred, and the use of phenoxyethyl acrylate is even more preferred. These compounds have the effect of reducing the viscosity and odor of the ink.

These additional polymerizable compounds may be used alone or in combination of two or more kinds.

The content of the additional polymerizable compound or compounds may be in a range of 5% by mass to 50% by mass, inclusive, relative to the total mass of the ink (100% by mass). In particular, when any polyfunctional acrylate is used, the polyfunctional acrylate content is preferably in a range of 5% by mass to 20% by mass, inclusive, and more preferably 8% by mass to 15% by mass, inclusive, relative to the total mass of the ink (100% by weight) so that excellent adhesiveness, rubfastness, and alcohol resistance of the ink can be ensured.

### Polymerization Inhibitor

The ink according to this embodiment may contain a polymerization inhibitor. Examples of suitable polymerization inhibitors include, but are not limited to, the following: phenols such as p-methoxyphenol, cresol, t-butylcatechol, di-t-butylparacresol, hydroquinone monomethyl ether, α-naphthol, 3,5-di-t-butyl-4-hydroxytoluene, 2,2′-methylene bis(4-methyl-6-t-butylphenol), 2,2′-methylene bis(4-ethyl-6-butylphenol), and 4,4′-thiobis(3-methyl-6-t-butylphenol); quinones such as p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-dibutylhydroquinone, mono-t-butylhydroquinone, monomethylhydroquinone and 2,5-di-t-amylhydroquinone; amines such as phenyl-β-naphthylamine, p-benzylaminophenol, di-β-naphthylparaphenylenediamine, dibenzylhydroxylamine, phenylhydroxylamine, and diethylhydroxylamine; nitro compounds such as dinitrobenzene, trinitrotoluene, and picric acid; oximes such as quinone dioxime and cyclohexanone oxime; and sulfur compounds such as phenotiazine.

### Photopolymerization Initiator

The ink according to this embodiment preferably contains a photopolymerization initiator. When any kind of photopolymerizable compound is used as a polymerizable compound, a separate photopolymerization initiator is unnecessary. However, the use of a separate photopolymerization initiator is preferred because it allows for easy control of the timing of the initiation of polymerization.

When the ink is exposed to radiation, the photopolymerization initiator is polymerized and thereby cures the portions of the ink existing on the recording medium; as a result, an image is formed. Examples of suitable kinds of radiations include γ-rays, β-rays, electron beams, ultraviolet light (UV), visible light, and infrared light. Among others, UV is preferred because of its high safety and the affordability of light sources. Any kind of photopolymerization initiator may be used as long as it can generate radicals, cations, or any other kind of active species using optical energy and thereby can initiate the polymerization of the polymerizable compound or compounds. For example, the photopolymerization initiator may be a radical or cationic photopolymerization initiator. In particular, the use of a radical photopolymerization initiator is preferred.

Examples of suitable radical photopolymerization initiators include aromatic ketones, acylphosphine oxides, aromatic onium salts, organic peroxides, thio compounds (e.g., thioxanthones and thiophenyl-group-containing compounds), hexaarylbiimidazoles, ketoxime esters, borates, azinium compounds, metallocenes, active esters, compounds having carbon-halogen bonds, and alkylamines.

In particular, acylphosphine oxides and thioxanthones give the ink good curability. Thus, the use of an acylphosphine oxide and/or a thioxanthone is preferred, and the use of an acylphosphine oxide is more preferred.

Specific examples of suitable radical photopolymerization initiators include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methyl propan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholinopropan-1-one, bis(2,4,6-trimethylbenzoyl)phenylphosphine oxide, 2,4,6-trimethylbenzoyldiphenylphosphine oxide, 2,4-diethylthioxanthone, and bis(2,6-dimethoxybenzoyl)-2,4,4-trimethylpentylphosphine oxide.

Examples of commercially available radical photopolymerization initiators include the following: IRGACURE 651 (2,2-dimethoxy-1,2-diphenylethan-1-one), IRGACURE 184 (1-hydroxycyclohexyl phenyl ketone), DAROCUR 1173 (2-hydroxy-2-methyl-1-phenylpropan-1-one), IRGACURE 2959 (1-[4-(2-hydroxyethoxy)phenyl]-2-hydroxy-2-methyl-1-propan-1-one), IRGACURE 127 (2-hydroxy-1-{4-[4-(2-hydroxy-2-methylpropionyl)benzyl]phenyl}-2-methylpropan-1-one), IRGACURE 907 (2-methyl-1-(4-methylthiophenyl)-2-morpholinopropan-1-one), IRGACURE 369 (2-benzyl-2-dimethylamino-1-(4-morpholinophenyl)-1-butanone), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyldiphenylphosphine oxide), IRGACURE 819 (bis(2,4,6-trimethylbenzoyl)phenylphosphine oxide), IRGACURE 784 (bis(η5-2,4-cyclopentadien-1-yl)-bis[2,6-difluoro-3-(1H-pyrrol-1-yl)-phenyl]titanium), IRGACURE OXE 01 (1-[4-(phenylthio)phenyl]-1,2-octandione 2-(O-benzoyloxime)), IRGACURE OXE 02 (1-[9-ethyl-6-(2-methylbenzoyl)-9H-carbazol-3-yl]ethanone 1-(O-acetyloxime)), IRGACURE 754 (a mixture of 2-(2-oxo-2-phenylacetoxyethoxy)ethyl oxyphenylacetate and 2-(2-hydroxyethoxy)ethyl oxyphenylacetate) (all these manufactured by BASF), KAYACURE DETX-S (2,4-diethylthioxanthone, manufactured by Nippon Kayaku Co., Ltd.), Speedcure TPO and Speedcure DETX (both manufactured by Lambson), Lucirin TPO, LR8893, and LR8970 (all these manufactured by BASF), and Ubecryl P36 (manufactured by UCB).

These photopolymerization initiators may be used alone or in combination of two or more kinds.

The photopolymerization initiator content is preferably in a range of 5% by mass to 20% by mass, inclusive, relative to the total mass of the ink (100% by mass). This allows the ink to be cured sufficiently fast and the photopolymerization initiator or initiators to be completely dissolved, and also prevents the photopolymerization initiator or initiators from adding its/their color to the ink.

### Coloring Material

The ink according to this embodiment may contain coloring material. When coloring material is used, it may be pigment, dye, or a combination of both.

### Pigment

In this embodiment, the use of pigment as coloring material imparts good light resistance to the ink. When pigment is used, it may be an inorganic or organic one.

Examples of suitable inorganic pigments include carbon blacks (C.I. Pigment Black 7) such as furnace black, lamp black, acetylene black, and channel black, iron oxide, and titanium oxide.

Examples of suitable organic pigments include azo pigments such as insoluble azo pigments, condensed azo pigments, azo lake pigments, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelate pigments (e.g., basic-dye chelate pigments and acid-dye chelate pigments), dye lake pigments (e.g., basic-dye lake pigments and acid-dye lake pigments), nitro pigments, nitroso pigments, aniline black, and daylight fluorescent pigments.

More specifically, examples of carbon blacks suitable when the ink is a black ink include No. 2300, No. 900, MCF88, No. 33, No. 40, No. 45, No. 52, MA7, MA8, MA100, No. 2200B, and other related products (all these manufactured by Mitsubishi Chemical Corporation), Raven 5750, Raven 5250, Raven 5000, Raven 3500, Raven 1255, Raven 700, and other related products (all these manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, Monarch 1400, and other related products (all these manufactured by CABOT JAPAN K.K.), and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all these manufactured by Degussa).

Examples of pigments suitable when the ink is a white ink include C.I. Pigment White 6, 18, and 21.

Examples of pigments suitable when the ink is a yellow ink include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments suitable when the ink is a magenta ink include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245 and C.I. Pigment Violet 19, 23, 32, 33, 36, 38, 43, and 50.

Examples of pigments suitable when the ink is a cyan ink include C.I. Pigment Blue 1, 2, 3, 15, 15:1, 15:2, 15:3, 15:34, 15:4, 16, 18, 22, 25, 60, 65, and 66 and C.I. Vat Blue 4 and 60.

Pigments of colors other than magenta, cyan, or yellow may also be used, including C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

These pigments may be used alone or in combination of two or more kinds.

When any of the pigments listed above is used, the average particle size of the pigment component is preferably equal to or smaller than 300 nm, and more preferably in a range of 50 nm to 250 nm, inclusive. When the pigment component has an average particle size in this range, the ink has its reliability such as ejection stability and pigment dispersion stability further improved, and the images formed therewith are of excellent quality. The average particle size as used herein is a value measured by dynamic light scattering.

### Dye

In this embodiment, dyes may also be used as coloring material. The kind of the dye is not particularly limited; acid dyes, direct dyes, reactive dyes, and basic dyes may be used. Examples of suitable dyes include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

These dyes may be used alone or in combination of two or more kinds.

When coloring material is used, its content is preferably in a range of 1% by mass to 25% by mass, inclusive, and more preferably 1% by mass to 20% by mass, inclusive, relative to the total mass of the ink (100% by mass) for excellent masking properties and color reproducibility.

### Dispersant

When the ink according to this embodiment contains a pigment component, the ink may contain a dispersant for better pigment dispersion. The kind of the dispersant is not particularly limited; polymeric dispersants and other kinds of dispersants commonly used to prepare pigment dispersion may be used. Specific examples include those mainly composed of one or more of the following substances: polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. Examples of commercially available polymeric dispersants include AJISPER line manufactured by Ajinomoto Fine-Techno Co., Inc., Solsperse line (e.g., Solsperse 3600) available from Avecia Co., DISPERBYK line manufactured by BYK, and DISPARLON line manufactured by Kusumoto Chemicals, Ltd.

### Slipping Agent

The ink according to this embodiment may further contain a slipping agent (a surfactant) for excellent rubfastness. The kind of the slipping agent is not particularly limited; silicone surfactants such as polyester- or polyether-modified silicones and other surfactants may be used, and the use of a polyester- or polyether-modified polydimethylsiloxane is particularly preferred. Specific examples include BYK-347, BYK-348, BYK-UV3500, BYK-UV3510, BYK-UV3530, and BYK-UV3570 (all these manufactured by BYK).

### Other Additives

The ink according to this embodiment may contain additives (ingredients) other than those mentioned above. The kinds of the additives are not particularly limited; additives such as known polymerization accelerators, penetration enhancers, and moisturizing agents (humectants) may be used. Additives other than these may also be used, including known fixatives, antimolds, antiseptics, antioxidants, radiation-absorbing agents, chelators, pH-adjusting agents, and thickeners.

### Recording Medium

The radiation-curable ink for ink jet recording according to this embodiment provides a record by, for example, being ejected onto a recording medium by the ink jet recording method described later. The recording medium is a package substrate or a semiconductor substrate. This is because inks for making markings on package/semiconductor substrates are required to have excellent adhesiveness, rubfastness, and alcohol resistance.

As defined above, the package substrate represents a protective substrate on which an electronic element such as a semiconductor chip is sealed, and the semiconductor substrate includes not only electronic elements such as semiconductor chips but also wafers that can be directly used as substrates. Electronic elements such as semiconductor chips are sealed to complete electronic components (IC packages). Each electronic component is used alone or in combination with others to constitute an electronic device.

Examples of appropriate formats of package substrates include insertion packages such as PGA (pin grid array), DIP (dual inline package), SIP (single inline package), ZIP (zigzag inline package), DO (diode outline) package, and TO (transistor outline) package, and surface-mount packages such as P-BGA (plastic ball grid array), T-BGA (tape ball grid array), F-BGA (fine pitch ball grid array), SOJ (small outline J-leaded), TSOP (thin small outline package), SON (small outline non-lead), QFP (quad flat package), CFP (ceramic flat package), SOT (small outline transistor), PLCC (plastic leaded chip carrier), LGA (land grid array), LLCC (leadless chip carrier), TCP (tape carrier package), LLP (leadless leadframe package), and DFN (dual flatpack non-lead).

Examples of commercially available package substrates include a general-purpose logic IC package (SOP14-P-300-1.27A) manufactured by Toshiba Semi-Conductor Co., Ltd., a surface-mount package (UPA2350B1G) manufactured by Renesas Electronics Corporation, a surface-mount package (P-LFBGA048-0606) manufactured by Sharp Corporation, and a serial EEPROM (BR24L01A) manufactured by ROHM Co., Ltd.

When a package substrate is used as the recording medium, examples of suitable materials for the substrate include nonabsorbent materials, which prevent the ink from penetrating into the electronic component body. Specific examples of suitable nonabsorbent materials include, but are not limited to, the following: metals such as gold, silver, copper, aluminum, iron-nickel alloys, stainless steel, and brass; inorganic materials such as semiconducting materials (e.g., silicon), carbides, nitrides (e.g., silicon nitride), and borides; and organic materials such as silicones, epoxy resins, phenol resins, polyimides, and polymethyl methacrylate (PMMA).

The material of the package substrate is preferably a silicone or an epoxy resin for better adhesiveness of the cured product to the substrate. The use of a package substrate made of a silicone or an epoxy resin as a seal for the electronic component allows the electronic component to hold a favorable marking made by the ink according to this embodiment on the outer surface of its substrate.

On the other hand, examples of commercially available semiconductor substrates (wafers) include 300-mm silicon wafers manufactured by Shin-Etsu Chemical Co., Ltd., silicon-on-insulator (SOI) wafers manufactured by SUMCO Corporation, and polished wafers manufactured by Covalent Materials Corporation.

When a semiconductor substrate is used as the recording medium, examples of preferred materials for the substrate include silicon, germanium, and selenium. Among these, silicon, which has excellent adhesiveness to ink and behaves as a highly stable semiconducting material, is preferred.

In addition, examples of appropriate electronic devices include USB flash drives, memory cards, and flash memory cards such as the following formats: SD, Memory Stick, SmartMedia, xD-Picture Card, and CompactFlash (registered trademarks).

The following describes a method for making markings on a package/semiconductor substrate.

When the recording medium is a wafer (a semiconductor substrate), the markings may be made before the wafer is diced or after circuits are formed on the wafer and the wafer is diced into semiconductor chips. In the latter case, usually, a silicon wafer is coated with a silicon oxide film while integrated circuits (ICs) are being formed thereon. This silicon oxide film can be formed by, for example, high-frequency sputtering, a process excellent in thickness control. By this process the target material, namely silicon dioxide, can be sputtered onto the silicon wafer.

On the other hand, when the recording medium is a package substrate, the markings may be formed before or after a semiconductor chip is sealed on the substrate.

An electronic component can be fabricated by bonding the pads on the semiconductor chip to a leadframe and then sealing the whole chip on the package substrate with a sealant. Examples of suitable sealants include, but are not limited to, epoxy resins, phenol resins, and silicones. The markings may be made on electronic components (i.e., on their casing) obtained in this way.

When the ink is applied to a nonabsorbent recording medium, drying and/or other operations may be necessary after the ink is cured by exposure to radiation.

In this way, this embodiment provides a radiation-curable ink for ink jet recording that has excellent adhesiveness, rubfastness, and alcohol resistance. More specifically, this embodiment provides a radiation-curable ink that has excellent adhesiveness to pretreated package/semiconductor substrates, excellent rubfastness, and excellent resistance to cleaning of flux (e.g., in IPA).

In addition, the above great advantages of the ink according to this embodiment are attributable in part to the heat treatment of the radiation-exposed ink under particular temperature conditions. This heat treatment is detailed later in Ink jet recording method section.

### Record

Another embodiment of this aspect of the invention relates to a record. The record is a package/semiconductor substrate (a recording medium) having thereon a cured product of the radiation-curable ink for ink jet recording according to the above embodiment; the record is composed of a package/semiconductor substrate and a cured product of the ink, and the package/semiconductor substrate holds thereon a marking made by the cured product. The record is characterized by excellent adhesion between the package/semiconductor substrate and the ink cured thereon (the cured product) and excellent rubfastness and alcohol resistance of the cured ink.

In this way, this embodiment provides a record made using a radiation-curable ink for ink jet recording having excellent adhesiveness, rubfastness, and alcohol resistance.

### Ink Jet Recording Method

Yet another embodiment of this aspect of the invention relates to an ink jet recording method. The ink jet recording method includes the following: ejecting the radiation-curable ink for ink jet recording according to the above embodiment onto a package/semiconductor substrate (a recording medium) in such a manner that the ink should adhere to the substrate; curing the ejected ink by exposure to active radiation; and heating the cured ink under particular conditions. By these operations the ink, exposed to radiation and heated on the package/semiconductor substrate, forms a cured product. The following details the individual operations.

### Ejection

In the ejection operation, known ink jet recording apparatuses may be used. The viscosity of the ink during the ink ejection is preferably equal to or lower than 30 mPa·s, and more preferably in a range of 5 mPa·s to 20 mPa·s, inclusive. When the viscosity of the ink is in this range at room temperature or with no heat applied to the ink, the ink is ejected after being adjusted to room temperature or with no heat applied thereto. If necessary, however, the ink may be heated to have a preferred viscosity before ejection. This ensures good ejection stability of the ink.

### Curing

Then, in the curing operation, the ink ejected onto the package/semiconductor substrate is cured by exposure to radiation (light).

More specifically, the polymerizable compound first starts to be polymerized upon exposure to radiation. In parallel with this, the photopolymerization initiator contained in the ink is degraded upon exposure to radiation and generates an initiating species such as a radical, an acid, or a base, and this initiating species works to promote the polymerization reaction of the polymerizable compound. When the ink contains a sensitizing dye in addition to the photopolymerization initiator, the molecules of the sensitizing dye in the system absorb the active radiation and thereby get into an excited state, and the excited molecules come into contact with the molecules of the photopolymerization initiator and promote the degradation of the photopolymerization initiator, allowing the system to complete curing reaction with improved sensitivity.

Mainstream radiation sources are mercury lamps, gas lasers, solid lasers, and so forth, and the curing of radiation-curable inks for ink jet recording is usually performed using a mercury lamp or a metal halide lamp as the light source. Considering the current trend toward environmental protection, however, mercury-free light sources are highly recommended; for example, GaN semiconductor UV light-emitting devices are of great value both industrially and environmentally. UV light-emitting diodes (UV-LEDs) and UV laser diodes (UV-LDs), which are small-sized, long-life, high-efficiency, low-cost light sources, are also promising for use as the light source in ink jet recording with a radiation-curable ink. Among these, UV-LEDs are preferred.

The radiation used in this operation preferably satisfies the following conditions so that the ink can be completely cured and the subsequent heat treatment can achieve the intended advantages: the emission peak wavelength of the radiation is preferably in a range of 350 nm to 405 nm, inclusive, and more preferably 365 nm to 395 nm, inclusive; the irradiation (total amount of the energy of the radiation) is preferably equal to or higher than 100 mJ/cm² and preferably equal to or lower than 600 mJ/cm², and more preferably in a range of 200 mJ/cm² to 500 mJ/cm², inclusive.

In addition, the radiation intensity is preferably equal to or lower than 500 mW/cm², and more preferably in a range of 200 mW/cm² to 400 mW/cm².

When these conditions are satisfied, the ink according to the above embodiment can be rapidly cured with low energy depending on its composition. The irradiation is the product of the exposure time and the radiation intensity. The ink according to the above embodiment can be cured in a reduced exposure time depending on its composition, and this leads to an increased printing speed. Furthermore, the ink according to the above embodiment can be cured with a reduced radiation intensity depending on its composition, and this leads to apparatus downsizing and cost reduction. The radiation source used for this purpose is preferably a UV-LED. The ink can provide these benefits when it contains a photopolymerization initiator that is degraded upon exposure to a radiation having a wavelength in the above range and when its polymerizable compound starts to be polymerized upon exposure to a radiation having a wavelength in the above range. In addition, the radiation may have two or more emission peak wavelengths in the above range rather than just one. The irradiation is the total amount of the energy of the radiation regardless of the number of emission peak wavelengths the radiation has in the above range.

### Heating

Then, in the heating operation, the ink cured in the curing operation described above is subjected to a heat treatment. This heat treatment presumably results in either or both of the following: any monomers and insufficiently polymerized portions of the polymerizable compound are polymerized, and thereby the degree of polymerization is increased; the polymers existing in the cured ink form a network structure upon being heated, and thereby the cured ink is further hardened. Thus, the cured product has excellent properties in all of rubfastness, alcohol resistance, and adhesiveness to its substrate, although the factors for this result are not limited to those mentioned above.

The heating temperature of this heat treatment is in a range of 150° C. to 200° C., inclusive, and preferably 160° C. to 190° C., inclusive. A heating temperature in this range ensures excellent properties of the cured product in all of rubfastness, adhesiveness, and alcohol resistance. Additionally, the heating time of this heat treatment is preferably in a range of 5 minutes to 75 minutes, inclusive, more preferably 10 minutes to 75 minutes, inclusive, and even more preferably 20 minutes to 70 minutes, inclusive. A heating temperature in this range ensures a minimized effect of the heat on the package/semiconductor substrate in addition to the excellent properties of the cured product mentioned above.

In this way, this embodiment provides an ink jet recording method that uses a radiation-curable ink for ink jet recording excellent in all of adhesiveness, rubfastness, and alcohol resistance.

The following details some embodiments of the second aspect of the invention. These embodiments do not limit this aspect of the invention; various modifications can be made without departing from the spirit of this aspect of the invention.

The following terms have the same meaning as defined in the description of the first aspect of the invention: package substrate, semiconductor substrate, package/semiconductor substrates, record, cured product, curing, curable, adhesiveness, rubfastness, alcohol resistance, ejection stability, (meth)acrylate, and (meth)acrylic.

### Radiation-Curable Ink for Ink Jet Recording

The radiation-curable ink for ink jet recording according to an embodiment of this aspect of the invention contains N-vinylcaprolactam and a polyfunctional (meth)acrylate. The N-vinylcaprolactam content of the ink is in a range of 5% by mass to 20% by mass, inclusive, relative to the total mass of the ink (100% by mass). The polyfunctional (meth)acrylate content of the ink is in a range of 5% by mass to 20% by mass, inclusive, relative to the total mass of the ink (100% by mass).

The following describes the essential ingredients of the radiation-curable ink for ink jet recording according to this embodiment and additives that may be contained in the ink as necessary.

### Polymerizable Compounds

The radiation-curable ink for ink jet recording according to this embodiment contains polymerizable compounds. When exposed to light, the polymerizable compounds are polymerized by the action of the photopolymerization initiator, described later, and thereby cure the printed portions of the ink.

### N-Vinylcaprolactam

In this embodiment, N-vinylcaprolactam is used as one of the polymerizable compounds. The ink, which contains N-vinylcaprolactam as one of the polymerizable compounds, shows good curability, adhesiveness, rubfastness, and alcohol resistance.

The N-vinylcaprolactam content is in a range of 5% by mass to 20% by mass, inclusive, and preferably 9% by mass to 15% by mass, inclusive, relative to the total mass of the ink (100% by mass). When the N-vinylcaprolactam content is in this range, the ink has excellent adhesiveness, rubfastness, and alcohol resistance.

### Polyfunctional (Meth)Acrylate

In this embodiment, a polyfunctional (meth)acrylate is used as another one of the polymerizable compounds. The ink according to this embodiment, which contains a polyfunctional (meth)acrylate as one of the polymerizable compounds in addition to the particular amount of N-vinylcaprolactam, has its adhesiveness, rubfastness, and alcohol resistance further improved.

Among polyfunctional (meth)acrylates, those having a pentaerythritol structure are preferred, including pentaerythritol tri(meth)acrylate, pentaerythritol tetra(meth)acrylate, and pentaerythritol ethoxy tetra(meth)acrylate. The use of pentaerythritol tri(meth)acrylate and/or pentaerythritol tetra (meth)acrylate is preferred, and the use of pentaerythritol triacrylate and/or pentaerythritol tetraacrylate is more preferred. These polyfunctional (meth)acrylates give the ink not only further improved adhesiveness, rubfastness, and alcohol resistance but also a reduced viscosity and an increased cross-linking density.

The polyfunctional (meth)acrylate content is in a range of 5% by mass to 20% by mass, inclusive, and preferably 8% by mass to 15% by mass, inclusive, relative to the total mass of the ink (100% by mass). When the polyfunctional (meth)acrylate content is in this range, the ink has excellent adhesiveness, rubfastness, and alcohol resistance.

However, the polyfunctional (meth)acrylate does not always have to be one having a pentaerythritol structure.

Examples of suitable polyfunctional (meth)acrylates other than those having a pentaerythritol structure include the following: bifunctional (meth)acrylates including triethyleneglycol di(meth)acrylate, tetraethyleneglycol di(meth)acrylate, polyethyleneglycol di(meth)acrylate, tripropyleneglycol di(meth)acrylate, polypropyleneglycol di(meth)acrylate, 1,4-butanediol di(meth)acrylate, 1,6-hexanediol di(meth)acrylate, 1,9-nonanediol di(meth)acrylate, neopentylglycol di(meth)acrylate, dimethylol-tricyclodecane di(meth)acrylate, bisphenol A di(meth)acrylate, hydroxypivalic acid neopentylglycol di(meth)acrylate, and polytetramethyleneglycol di(meth)acrylate; and trifunctional and other polyfunctional (meth)acrylates such as trimethylolpropane tri(meth)acrylate, glycerol propoxy tri(meth)acrylate, caprolactone-modified trimethylolpropane tri(meth)acrylate, ditrimethylolpropane tetra(meth)acrylate, and sorbitol penta(meth)acrylate, (meth)acrylates having a dipentaerythritol structure, e.g., dipentaerythritol hexa(meth)acrylate, caprolactam-modified dipentaerythritol hexa(meth)acrylate, dipentaerythritol penta(meth)acrylate, and caprolactone-modified dipentaerythritol hexa(meth)acrylate, (meth)acrylates having a tripentaerythritol structure, e.g., propionic-acid-modified tripentaerythritol penta(meth)acrylate, tripentaerythritol hexa(meth)acrylate, tripentaerythritol hepta(meth)acrylate, and tripentaerythritol octa(meth)acrylate, (meth)acrylates having a tetrapentaerythritol structure, e.g., tetrapentaerythritol penta(meth)acrylate, tetrapentaerythritol hexa(meth)acrylate, tetrapentaerythritol hepta(meth)acrylate, tetrapentaerythritol octa(meth)acrylate, tetrapentaerythritol nona(meth)acrylate, and tetrapentaerythritol deca(meth)acrylate, (meth)acrylates having a pentapentaerythritol structure, e.g., pentapentaerythritol undeca(meth)acrylate, pentapentaerythritol dodeca(meth)acrylate, and their ethylene oxide (EO) and/or propylene oxide (PO) adducts.

### Other Polymerizable Compounds

The ink according to this embodiment may contain polymerizable compounds other than the above two.

Examples of suitable polymerizable compounds other than the above two (hereinafter referred to as additional polymerizable compounds) include various kinds of known monomers and oligomers including monofunctional, bifunctional, trifunctional, and other polyfunctional ones.

Examples of monomers suitable for use as additional polymerizable compounds include unsaturated carboxylic acids such as (meth)acrylic acid, itaconic acid, corotonic acid, isocrotonic acid, and maleic acid and their salts, esters, urethanes, amides, and anhydrides, acrylonitrile, styrene, various kinds of unsaturated polyesters, unsaturated polyethers, unsaturated polyamides, and unsaturated urethanes. Examples of oligomers suitable for use as additional polymerizable compounds include linear acrylic oligomers and other oligomers derived from the monomers listed above, epoxy (meth)acrylates, oxetane (meth)acrylates, aliphatic urethane (meth)acrylates, aromatic urethane (meth)acrylates, and polyester (meth)acrylates.

Examples of monofunctional (meth)acrylates suitable for use as additional polymerizable compounds include the following: isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethyl hexyl-diglycol (meth)acrylate, 2-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylate, t-butyl cyclohexyl (meth)acrylate, dicyclopentanyl (meth)acrylate, and dicyclopentenyloxyethyl (meth)acrylate.

Furthermore, the following compounds may be used as additional polymerizable compounds: 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethyl propyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethyl cyclohexyl methyl (meth)acrylate, 3-vinyloxymethyl cyclohexyl methyl (meth)acrylate, 2-vinyloxymethyl cyclohexyl methyl (meth)acrylate, p-vinyloxymethyl phenyl methyl (meth)acrylate, m-vinyloxymethyl phenyl methyl (meth)acrylate, o-vinyloxymethyl phenyl methyl (meth)acrylate, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate.

In addition, when any monofunctional (meth)acrylate is used, the use of phenoxyethyl (meth)acrylate and/or isobornyl (meth)acrylate is preferred, the use of phenoxyethyl (meth)acrylate is more preferred, and the use of phenoxyethyl acrylate is even more preferred. These compounds have the effect of reducing the viscosity and odor of the ink.

These additional polymerizable compounds may be used alone or in combination of two or more kinds.

The content of the additional polymerizable compound or compounds may be in a range of 5% by mass to 70% by mass, inclusive, relative to the total mass of the ink (100% by mass).

### Polymerization Inhibitor

The ink according to this embodiment may contain a polymerization inhibitor. Examples of suitable polymerization inhibitors include, but are not limited to, the following: phenols such as p-methoxyphenol, cresol, t-butylcatechol, di-t-butylparacresol, hydroquinone monomethyl ether, α-naphthol, 3,5-di-t-butyl-4-hydroxytoluene, 2,2′-methylene bis(4-methyl-6-t-butylphenol), 2,2′-methylene bis(4-ethyl-6-butylphenol), and 4,4′-thiobis(3-methyl-6-t-butylphenol); quinones such as p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-dibutylhydroquinone, mono-t-butylhydroquinone, monomethylhydroquinone and 2,5-di-t-amylhydroquinone; amines such as phenyl-β-naphthylamine, p-benzylaminophenol, di-β-naphthylparaphenylenediamine, dibenzylhydroxylamine, phenylhydroxylamine, and diethylhydroxylamine; nitro compounds such as dinitrobenzene, trinitrotoluene, and picric acid; oximes such as quinone dioxime and cyclohexanone oxime; and sulfur compounds such as phenotiazine.

### Photopolymerization Initiator

The ink according to this embodiment preferably contains a photopolymerization initiator. When any kind of photopolymerizable compound is used as a polymerizable compound, a separate photopolymerization initiator is unnecessary. However, the use of a separate photopolymerization initiator is preferred because it allows for easy control of the timing of the initiation of polymerization.

When the ink is exposed to radiation, this photopolymerization initiator is polymerized and thereby cures the portions of the ink existing on the recording medium; as a result, an image is formed. Examples of suitable kinds of radiations include γ-rays, β-rays, electron beams, ultraviolet light (UV), visible light, and infrared light. Among others, UV is preferred because of its high safety and the affordability of light sources. Any kind of photopolymerization initiator may be used as long as it can generate radicals, cations, or any other kind of active species using optical energy and thereby can initiate the polymerization of the polymerizable compounds; for example, the photopolymerization initiator may be a radical or cationic photopolymerization initiator. In particular, the use of a radical photopolymerization initiator is preferred.

Examples of suitable radical photopolymerization initiators include aromatic ketones, acylphosphine oxides, aromatic onium salts, organic peroxides, thio compounds (e.g., thioxanthones and thiophenyl-group-containing compounds), hexaarylbiimidazoles, ketoxime esters, borates, azinium compounds, metallocenes, active esters, compounds having carbon-halogen bonds, and alkylamines.

In particular, acylphosphine oxides and thioxanthones give the ink good curability. Thus, the use of an acylphosphine oxide and/or a thioxanthone is preferred, and the use of an acylphosphine oxide is more preferred.

Specific examples of suitable radical photopolymerization initiators include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methyl propan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholinoropan-1-one, bis(2,4,6-trimethylbenzoyl)phenylphosphine oxide, 2,4,6-trimethylbenzoyldiphenylphosphine oxide, 2,4-diethylthioxanthone, and bis(2,6-dimethoxybenzoyl)-2,4,4-trimethylpentylphosphine oxide.

Examples of commercially available radical photopolymerization initiators include the following: IRGACURE 651 (2,2-dimethoxy-1,2-diphenylethan-1-one), IRGACURE 184 (1-hydroxycyclohexyl phenyl ketone), DAROCUR 1173 (2-hydroxy-2-methyl-1-phenylpropan-1-one), IRGACURE 2959 (1-[4-(2-hydroxyethoxy)phenyl]-2-hydroxy-2-methyl-1-propan-1-one), IRGACURE 127 (2-hydroxy-1-{4-[4-(2-hydroxy-2-methylpropionyl)benzyl]phenyl}-2-methylpropan-1-one), IRGACURE 907 (2-methyl-1-(4-methylthiophenyl)-2-morpholinopropan-1-one), IRGACURE 369 (2-benzyl-2-dimethylamino-1-(4-morpholinophenyl)-1-butanone), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyldiphenylphosphine oxide), IRGACURE 819 (bis(2,4,6-trimethylbenzoyl)phenylphosphine oxide), IRGACURE 784 (bis(η5-2,4-cyclopentadien-1-yl)-bis[2,6-difluoro-3-(1H-pyrrol-1-yl)-phenyl]titanium), IRGACURE OXE 01 (1-[4-(phenylthio)phenyl]-1,2-octandione 2-(O-benzoyloxime)), IRGACURE OXE 02 (1-[9-ethyl-6-(2-methylbenzoyl)-9H-carbazol-3-yl]ethanone 1-(O-acetyloxime)), IRGACURE 754 (a mixture of 2-(2-oxo-2-phenylacetoxyethoxy)ethyl oxyphenylacetate and 2-(2-hydroxyethoxy)ethyl oxyphenylacetate) (all these manufactured by BASF), KAYACURE DETX-S (2,4-diethylthioxanthone, manufactured by Nippon Kayaku Co., Ltd.), Speedcure TPO and Speedcure DETX (both manufactured by Lambson), Lucirin TPO, LR8893, and LR8970 (all these manufactured by BASF), and Ubecryl P36 (manufactured by UCB).

These photopolymerization initiators may be used alone or in combination of two or more kinds.

The photopolymerization initiator content is preferably in a range of 5% by mass to 20% by mass, inclusive, relative to the total mass of the ink (100% by mass). This allows the ink to be cured sufficiently fast and the photopolymerization initiator or initiators to be completely dissolved, and also prevents the photopolymerization initiator or initiators from adding its/their color to the ink.

### Coloring Material

The ink according to this embodiment may contain coloring material. When coloring material is used, it may be pigment, dye, or a combination of both.

### Pigment

In this embodiment, the use of pigment as coloring material imparts good light resistance to the ink. When pigment is used, it may be an inorganic or organic one.

Examples of suitable inorganic pigments include carbon blacks (C.I. Pigment Black 7) such as furnace black, lamp black, acetylene black, and channel black, iron oxide, and titanium oxide.

Examples of suitable organic pigments include azo pigments such as insoluble azo pigments, condensed azo pigments, azo lake pigments, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelate pigments (e.g., basic-dye chelate pigments and acid-dye chelate pigments), dye lake pigments (e.g., basic-dye lake pigments and acid-dye lake pigments), nitro pigments, nitroso pigments, aniline black, and daylight fluorescent pigments.

More specifically, examples of carbon blacks suitable when the ink is a black ink include No. 2300, No. 900, MCF88, No. 33, No. 40, No. 45, No. 52, MA7, MA8, MA100, No. 2200B, and other related products (all these manufactured by Mitsubishi Chemical Corporation), Raven 5750, Raven 5250, Raven 5000, Raven 3500, Raven 1255, Raven 700, and other related products (all these manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, Monarch 1400, and other related products (all these manufactured by CABOT JAPAN K.K.), and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all these manufactured by Degussa).

Examples of pigments suitable when the ink is a white ink include C.I. Pigment White 6, 18, and 21.

Examples of pigments suitable when the ink is a yellow ink include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments suitable when the ink is a magenta ink include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245 and C.I. Pigment Violet 19, 23, 32, 33, 36, 38, 43, and 50.

Examples of pigments suitable when the ink is a cyan ink include C.I. Pigment Blue 1, 2, 3, 15, 15:1, 15:2, 15:3, 15:34, 15:4, 16, 18, 22, 25, 60, 65, and 66 and C.I. Vat Blue 4 and 60.

Pigments of a color other than magenta, cyan, or yellow may also be used, including C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

These pigments may be used alone or in combination of two or more kinds.

When any of the pigments listed above is used, the average particle size of the pigment component is preferably equal to or smaller than 300 nm, and more preferably in a range of 50 nm to 250 nm, inclusive. When the pigment component has an average particle size in this range, the ink has its reliability such as ejection stability and pigment dispersion stability further improved, and the images formed therewith are of excellent quality. As mentioned in the description of the first aspect of the invention, the average particle size as used herein is a value measured by dynamic light scattering.

### Dye

In this embodiment, dyes may also be used as coloring material. The kind of dye is not particularly limited; acid dyes, direct dyes, reactive dyes, and basic dyes may be used. Examples of suitable dyes include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

These dyes may be used alone or in combination of two or more kinds.

When any coloring material is used, its content is preferably in a range of 1% by mass to 20% by mass, inclusive, and more preferably 2% by mass to 15% by mass, inclusive, relative to the total mass of the ink (100% by mass) for excellent masking properties and color reproducibility.

### Dispersant

When the ink according to this embodiment contains a pigment component, the ink may contain a dispersant for better pigment dispersion. The kind of the dispersant is not particularly limited; polymeric dispersants and other kinds of dispersants commonly used to prepare pigment dispersion may be used. Specific examples include those mainly composed of one or more of the following substances: polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. Examples of commercially available polymeric dispersants include AJISPER line manufactured by Ajinomoto Fine-Techno Co., Inc., Solsperse line (e.g., Solsperse 3600) available from Avecia Co., DISPERBYK line manufactured by BYK, and DISPARLON line manufactured by Kusumoto Chemicals, Ltd.

### Slipping Agent

The ink according to this embodiment may further contain a slipping agent (a surfactant) for excellent rubfastness. The kind of the slipping agent is not particularly limited; silicone surfactants such as polyester- or polyether-modified silicones and other surfactants may be used, and the use of a polyester- or polyether-modified polydimethylsiloxane is particularly preferred. Specific examples include BYK-347, BYK-348, BYK-UV3500, BYK-UV3510, BYK-UV3530, and BYK-UV3570 (all these manufactured by BYK).

### Other Additives

The ink according to this embodiment may contain additives (ingredients) other than those mentioned above. The kinds of the additives are not particularly limited; additives such as known polymerization accelerators, penetration enhancers, and moisturizing agents (humectants) may be used. Additives other than these may also be used, including known fixatives, antimolds, antiseptics, antioxidants, radiation-absorbing agents, chelators, pH-adjusting agents, and thickeners.

### Recording Medium

The radiation-curable ink for ink jet recording according to this embodiment forms a record by, for example, being ejected onto a recording medium by the ink jet recording method described later. The recording medium is a package substrate or a semiconductor substrate. This is because inks for making markings on package/semiconductor substrates are required to have excellent adhesiveness, rubfastness, and alcohol resistance.

As defined above, the package substrate represents a protective substrate on which an electronic element such as a semiconductor chip is sealed, and the semiconductor substrate includes not only electronic elements such as semiconductor chips but also wafers that can be directly used as substrates. Electronic elements such as semiconductor chips are sealed to complete electronic components (IC packages). Each electronic component is used alone or in combination with others to constitute an electronic device.

Examples of appropriate formats of package substrates include insertion packages such as PGA (pin grid array), DIP (dual inline package), SIP (single inline package), ZIP (zigzag inline package), DO (diode outline) package, and TO (transistor outline) package, and surface-mount packages such as P-BGA (plastic ball grid array), T-BGA (tape ball grid array), F-BGA (fine pitch ball grid array), SOJ (small outline J-leaded), TSOP (thin small outline package), SON (small outline non-lead), QFP (quad flat package), CFP (ceramic flat package), SOT (small outline transistor), PLCC (plastic leaded chip carrier), LGA (land grid array), LLCC (leadless chip carrier), TCP (tape carrier package), LLP (leadless leadframe package), and DFN (dual flatpack non-lead).

Examples of commercially available package substrates include a general-purpose logic IC package (SOP14-P-300-1.27A) manufactured by Toshiba Semi-Conductor Co., Ltd., a surface-mount package (UPA2350B1G) manufactured by Renesas Electronics Corporation, a surface-mount package (P-LFBGA048-0606) manufactured by Sharp Corporation, and a serial EEPROM (BR24L01A) manufactured by ROHM Co., Ltd.

When a package substrate is used as the recording medium, examples of suitable materials for the substrate include nonabsorbent materials, which prevent the ink from penetrating into the electronic component body. Specific examples of suitable nonabsorbent materials include, but are not limited to, the following: metals such as gold, silver, copper, aluminum, iron-nickel alloys, stainless steel, and brass; inorganic materials such as semiconducting materials (e.g., silicon), carbides, nitrides (e.g., silicon nitride), and borides; and organic materials such as silicones, epoxy resins, phenol resins, polyimides, and polymethyl methacrylate (PMMA).

The material of the package substrate is preferably a silicone or an epoxy resin for better adhesiveness of the cured product to the substrate. The use of a package substrate made of a silicone or an epoxy resin as a seal for the electronic component allows the electronic component to hold a favorable marking made by the ink according to this embodiment on the outer surface of its substrate.

On the other hand, examples of commercially available semiconductor substrates (wafers) include 300-mm silicon wafers manufactured by Shin-Etsu Chemical Co., Ltd., silicon-on-insulator (SOI) wafers manufactured by SUMCO Corporation, and polished wafers manufactured by Covalent Materials Corporation.

When a semiconductor substrate is used as the recording medium, examples of preferred materials for the substrate include silicon, germanium, and selenium. Among these, silicon, which has excellent adhesiveness to ink and behaves as a highly stable semiconducting material, is preferred.

In addition, examples of appropriate electronic devices include USB flash drives, memory cards, and flash memory cards such as the following formats: SD, Memory Stick, SmartMedia, xD-Picture Card, and CompactFlash (registered trademarks).

The following describes a method for making markings on a package/semiconductor substrate.

When the recording medium is a wafer (a semiconductor substrate), the markings may be made before the wafer is diced or after circuits are formed on the wafer and the wafer is diced into semiconductor chips. In the latter case, usually, a silicon wafer is coated with a silicon oxide film while ICs are being formed thereon. This silicon oxide film can be formed by, for example, high-frequency sputtering, a process excellent in terms of thickness control. By this process the target material, namely silicon dioxide, can be sputtered onto the silicon wafer.

On the other hand, when the recording medium is a package substrate, the markings may be formed before or after a semiconductor chip is sealed on the substrate.

An electronic component can be fabricated by bonding the pads on the semiconductor chip to a leadframe and then sealing the whole chip on the package substrate with a sealant. Examples of suitable sealants include, but are not limited to, epoxy resins, phenol resins, and silicones. The markings may be made on electronic components (i.e., on their casing) obtained in this way.

When the ink is applied to a nonabsorbent recording medium, drying and/or other operations may be necessary after the ink is cured by exposure to radiation.

In this way, this embodiment provides a radiation-curable ink for ink jet recording that has excellent adhesiveness, rubfastness, and alcohol resistance. More specifically, this embodiment provides a radiation-curable ink that has excellent adhesiveness to pretreated package/semiconductor substrates, excellent rubfastness, and excellent resistance to cleaning of flux (e.g., in IPA).

### Record

Another embodiment of this aspect of the invention relates to a record. The record is a package/semiconductor substrate (a recording medium) having thereon a cured product of the radiation-curable ink for ink jet recording according to the above embodiment; the record is composed of a package/semiconductor substrate and a cured product of the ink, and the package/semiconductor substrate holds thereon a marking made by the cured product. The record is characterized by excellent adhesion between the package/semiconductor substrate and the ink cured thereon (the cured product) and excellent rubfastness and alcohol resistance of the cured ink.

In this way, this embodiment provides a record made using a radiation-curable ink for ink jet recording having excellent adhesiveness, rubfastness, and alcohol resistance.

### Ink Jet Recording Method

Yet another embodiment of this aspect of the invention relates to an ink jet recording method. This ink jet recording method includes the following: ejecting the radiation-curable ink for ink jet recording according to the above embodiment onto a package/semiconductor substrate (a recording medium) in such a manner that the ink should adhere to the substrate; and curing the ejected ink by exposure to active radiation. By these operations the ink, exposed to radiation on the package/semiconductor substrate, forms a cured product. The following details the individual operations.

### Ejection

In the ejection operation, known ink jet recording apparatuses may be used. The viscosity of the ink during the ink ejection is preferably equal to or lower than 30 mPa·s, and more preferably in a range of 5 mPa·s to 20 mPa·s, inclusive. When the viscosity of the ink is in this range at room temperature or with no heat applied to the ink, the ink is ejected after being adjusted to room temperature or with no heat applied thereto. If necessary, however, the ink may be heated to have a preferred viscosity before ejection. This ensures good ejection stability of the ink.

### Curing

Then, in the curing operation, the ink ejected onto the package/semiconductor substrate is cured by exposure to radiation (light).

More specifically, the polymerizable compounds first start to be polymerized upon exposure to radiation. In parallel with this, the photopolymerization initiator contained in the ink is degraded upon exposure to radiation and generates an initiating species such as a radical, an acid, or a base, and this initiating species works to promote the polymerization reaction of the polymerizable compounds. When the ink contains a sensitizing dye in addition to the photopolymerization initiator, the molecules of the sensitizing dye in the system absorb the active radiation and thereby get into an excited state, and the excited molecules come into contact with the molecules of the photopolymerization initiator and promote the degradation of the photopolymerization initiator, allowing the system to complete curing reaction with improved sensitivity.

As mentioned above, mainstream radiation sources are mercury lamps, gas lasers, solid lasers, and so forth, and the curing of radiation-curable inks for ink jet recording is usually performed using a mercury lamp or a metal halide lamp as the light source. Mercury-free light sources are highly recommended for environmental protection, and GaN semiconductor UV light-emitting devices are of great value both industrially and environmentally. UV-LEDs and UV-LDs are small-sized, long-life, high-efficiency, low-cost light sources and are promising for use as the light source in ink jet recording with a radiation-curable ink, and, among these, UV-LEDs are preferred.

The radiation used in this operation preferably satisfies the following conditions so that the ink can be completely cured: the emission peak wavelength of the radiation is preferably in a range of 350 nm to 405 nm, inclusive, and more preferably 365 nm to 395 nm, inclusive; and the irradiation (total amount of the energy of the radiation) is preferably equal to or lower than 800 mJ/cm², and more preferably in a range of 100 mJ/cm² to 700 mJ/cm², inclusive.

In addition, the radiation intensity is preferably equal to or lower than 800 mW/cm², and more preferably in a range of 200 mW/cm² to 500 mW/cm².

When these conditions are satisfied, the ink according to the above embodiment can be rapidly cured with low energy depending on its composition. The irradiation is the product of the exposure time and the radiation intensity. The ink according to the above embodiment can be cured in a reduced exposure time depending on its composition, and this leads to an increased printing speed. Furthermore, the ink according to the above embodiment can be cured with a reduced radiation intensity depending on its composition, and this leads to apparatus downsizing and cost reduction. The radiation source used for this purpose is preferably a UV-LED. The ink can provide these benefits when it contains a photopolymerization initiator that is degraded upon exposure to a radiation having a wavelength in the above range and when its polymerizable compounds start to be polymerized upon exposure to a radiation having a wavelength in the above range. In addition, the radiation may have two or more emission peak wavelengths in the above range rather than just one. The irradiation is the total amount of the energy of the radiation regardless of the number of emission peak wavelengths the radiation has in the above range.

In this way, this embodiment provides an ink jet recording method that uses a radiation-curable ink for ink jet recording excellent in all of adhesiveness, rubfastness, and alcohol resistance.

### EXAMPLES

The following details the first aspect of the invention with reference to its examples; however, this aspect is not limited to these examples.

### Raw Materials

In the examples and comparative examples below, the following raw materials were used.

### Polymerizable Compounds

N-vinylcaprolactam (manufactured by BASF; “NVC” in Table 1)
VEEA (2-(2-vinyloxyethoxy)ethyl acrylate, a trade name of Nippon Shokubai Co., Ltd.)
PET3A (pentaerythritol triacrylate, a trade name of OSAKA ORGANIC CHEMICAL INDUSTRY LTD.)
PETA-K (pentaerythritol tetraacrylate, a trade name of DAICEL-CYTEC Co., Ltd.)
Viscoat #192 (phenoxyethyl acrylate, a trade name of OSAKA ORGANIC CHEMICAL INDUSTRY LTD.; “PEA” in Table 1)

### Photopolymerization Initiators

IRGACURE 819 (100% solids bis(2,4,6-trimethylbenzoyl)phenylphosphine oxide, a trade name of BASF; “819” in Table 1)
DAROCURE TPO (100% solids 2,4,6-trimethylbenzoyldiphenylphosphine oxide, a trade name of BASF; “TPO” in Table 1)

### Slipping Agent

Silicone surface conditioner BYK-UV3500 (a polydimethylsiloxane having a polyether-modified acryl group, a trade name of BYK; “UV3500” in Table 1)

### Polymerization Inhibitor

p-Methoxyphenol (manufactured by KANTO CHEMICAL Co., INC.; “MEHQ” in Table 1)

### Pigment

R-630 (titanium oxide, a trade name of ISHIHARA SANGYO KAISHA, LTD.; “TiO₂” in Table 1)

### Dispersant

Solsperse 36000 (a trade name of LUBRIZOL; “Sol 36000” in Table 1)

### Substrates

Substrate 1 (package substrate): Epoxy resin surface 1 (surface-mount package P-LFBGA048-0606, manufactured by Sharp Corporation)
Substrate 2 (package substrate): Epoxy resin surface (serial EEPROM BR24L01A, manufactured by ROHM Co., Ltd.)
Substrate 3 (semiconductor substrate): Silicon surface 1 (a 300-mm silicon wafer, manufactured by Shin-Etsu Chemical Co., Ltd.)
Substrate 4 (semiconductor substrate): Silicon surface 2 (an SOI wafer, manufactured by SUMCO Corporation)

Substrates 3 and 4 were used after circuits were formed on the wafer and the wafer was diced into semiconductor chips. Each wafer was coated with a silicon oxide film having a thickness of 50 nm during the circuit formation.

### Examples 1 to 17 and Comparative Examples 1 to 4

### Preparation of Radiation-Curable Inks for Ink Jet Recording

The ingredients listed in Tables 1 and 2 were blended in accordance with the proportions (unit of measurement: % by mass) specified in Tables 1 and 2, and the mixtures were stirred at room temperature for 1 hour and thereby complete dissolution was achieved. The obtained solutions were each filtered through a 5 μm membrane filter. In this way, radiation-curable inks for ink jet recording were obtained.

TABLE 1

| | | | | | | | | | | | Exam- |
|---|---|---|---|---|---|---|---|---|---|---|---|
| | | Example 1 | Example 2 | Example 3 | Example 4 | Example 5 | Example 6 | Example 7 | Example 8 | Example 9 | ple 10 |
| Polymerizable | NVC | 10.0 | 10.0 | 9.6 | 5.0 | 13.0 | 9.1 | 15.0 | 9.1 | 15.0 | 15.0 |
| compounds | VEEA | 38.0 | 40.0 | 42.0 | 50.0 | 20.0 | 43.0 | 20.0 | 43.0 | 32.0 | — |
| | PET3A | 15.0 | 5.0 | 12.0 | 11.6 | 20.0 | — | 18.0 | 12.0 | 5.0 | 20.0 |
| | PETA-K | — | — | — | — | — | 12.0 | — | — | — | — |
| | PEA | 5.6 | 13.6 | 5.0 | 2.0 | 15.6 | 4.5 | 15.6 | 4.5 | 16.6 | 33.6 |
| Photopolymerization | 819 | 4.0 | 4.0 | 4.0 | 4.0 | 4.0 | 4.0 | 4.0 | 4.0 | 4.0 | 4.0 |
| initiators | TPO | 5.0 | 5.0 | 5.0 | 5.0 | 5.0 | 5.0 | 5.0 | 5.0 | 5.0 | 5.0 |
| Slipping agent | UV | 0.2 | 0.2 | 0.2 | 0.2 | 0.2 | 0.2 | 0.2 | 0.2 | 0.2 | 0.2 |
| | 3500 | | | | | | | | | | |
| Polymerization | MEHQ | 0.20 | 0.20 | 0.20 | 0.20 | 0.20 | 0.20 | 0.20 | 0.20 | 0.20 | 0.20 |
| inhibitor | | | | | | | | | | | |
| Pigment | TiO₂ | 20.0 | 20.0 | 20.0 | 20.0 | 20.0 | 20.0 | 20.0 | 20.0 | 20.0 | 20.0 |
| Dispersant | Sol 36000 | 2.0 | 2.0 | 2.0 | 2.0 | 2.0 | 2.0 | 2.0 | 2.0 | 2.0 | 2.0 |

| | | | | | | | | | | |
|---|---|---|---|---|---|---|---|---|---|---|
| Total | 100.0 | 100.0 | 100.0 | 100.0 | 100.0 | 100.0 | 100.0 | 100.0 | 100.0 | 100.0 |
| Substrate No. | 1 | 1 | 1 | 1 | 1 | 1 | 1 | 1 | 1 | 1 |

| | | Example | Example | Example | Example | Example | Example | Example |
|---|---|---|---|---|---|---|---|---|
| | | 11 | 12 | 13 | 14 | 15 | 16 | 17 |
| Polymerizable | NVC | 20.0 | 10.0 | 10.0 | 10.0 | 5.0 | 20.0 | 15.0 |
| compounds | VEEA | 30.0 | 38.0 | 38.0 | 38.0 | 33.0 | 32.0 | 15.0 |
| | PET3A | 10.0 | 15.0 | 15.0 | 15.0 | 3.0 | 4.6 | 25.0 |
| | PETA-K | — | — | — | — | — | — | — |
| | PEA | 8.6 | 5.6 | 5.6 | 5.6 | 27.6 | 12.0 | 13.6 |
| Photopolymerization | 819 | 4.0 | 4.0 | 4.0 | 4.0 | 4.0 | 4.0 | 4.0 |
| initiators | TPO | 5.0 | 5.0 | 5.0 | 5.0 | 5.0 | 5.0 | 5.0 |
| Slipping agent | UV | 0.2 | 0.2 | 0.2 | 0.2 | 0.2 | 0.2 | 0.2 |
| | 3500 | | | | | | | |
| Polymerization | MEHQ | 0.20 | 0.20 | 0.20 | 0.20 | 0.20 | 0.20 | 0.20 |
| inhibitor | | | | | | | | |
| Pigment | TiO₂ | 20.0 | 20.0 | 20.0 | 20.0 | 20.0 | 20.0 | 20.0 |
| Dispersant | Sol 36000 | 2.0 | 2.0 | 2.0 | 2.0 | 2.0 | 2.0 | 2.0 |

| | | | | | | | |
|---|---|---|---|---|---|---|---|
| Total | 100.0 | 100.0 | 100.0 | 100.0 | 100.0 | 100.0 | 100.0 |
| Substrate No. | 1 | 2 | 3 | 4 | 1 | 1 | 1 |

TABLE 2

| | | Compara- | Compara- | Compara- | Compara- |
|---|---|---|---|---|---|
| | | tive Ex- | tive Ex- | tive Ex- | tive Ex- |
| | | ample 1 | ample 2 | ample 3 | ample 4 |
| Polymer- | NVC | 4.5 | 25.0 | 25.0 | 25.0 |
| izable | VEEA | — | — | — | — |
| compounds | PET3A | 20.0 | 29.0 | — | 15.0 |
| | PETA-K | — | — | — | — |
| | PEA | 44.1 | 14.6 | 43.6 | 28.6 |
| Photopoly- | 819 | 4.0 | 4.0 | 4.0 | 4.0 |
| merization | TPO | 5.0 | 5.0 | 5.0 | 5.0 |
| initiators | | | | | |
| Slipping | UV3500 | 0.2 | 0.2 | 0.2 | 0.2 |
| agent | | | | | |
| Polymeriza- | MEHQ | 0.2 | 0.2 | 0.2 | 0.2 |
| tion inhibitor | | | | | |
| Pigment | TiO₂ | 20.0 | 20.0 | 20.0 | 20.0 |
| Dispersant | Sol | 2.0 | 2.0 | 2.0 | 2.0 |
| | 36000 | | | | |

| | | | | |
|---|---|---|---|---|
| Total | 100.0 | 100.0 | 100.0 | 100.0 |
| Substrate No. | 1 | 1 | 1 | 1 |

### Preparation of Ink Coatings

### System 1

Substrates 1 to 4 were each pretreated by exposure to light from a low-pressure mercury lamp. In accordance with the combinations of inks and substrates given in Tables 1 and 2, a solid image was printed on the pretreated substrates using an ink jet printer (PX-75505 [trade name], manufactured by Seiko Epson Corporation). The thickness of the print (image) was set at 10 μm. The solid image represents an image having all of its pixels (the smallest unit of picture defined by the recording resolution) occupied by dots.

The substrates were then heated at 190° C. for 20 minutes without exposure to radiation. In this way, records were obtained.

### System 2

Substrates 1 to 4 were each pretreated by exposure to light from a low-pressure mercury lamp. In accordance with the combinations of inks and substrates given in Tables 1 and 2, a solid image was printed on the pretreated substrates using an ink jet printer (PX-75505 [trade name], manufactured by Seiko Epson Corporation). The thickness of the print (image) was set at 10 μm. The substrates were then exposed to radiation under the following conditions and thereby the ink was cured: wavelength: 395 nm; radiation intensity: 400 mW/cm²; maximum irradiation: 2,400 mJ/cm². In this way, records were obtained.

### System 3

Substrates 1 to 4 were each pretreated by exposure to light from a low-pressure mercury lamp. In accordance with the combinations of inks and substrates given in Tables 1 and 2, a solid image was printed on the pretreated substrates using an ink jet printer (PX-75505 [trade name], manufactured by Seiko Epson Corporation). The thickness of the print (image) was set at 10 μm. The substrates were then exposed to radiation under the following conditions and thereby the ink was cured: wavelength: 395 nm; radiation intensity: 400 mW/cm²; maximum irradiation: 450 mJ/cm².

The substrates were then heated at 130° C. for 60 minutes. In this way, records were obtained.

### System 4

Records were obtained in the same way as those of system 3 except that the substrates were heated at 160° C. for 70 minutes.

### System 5

Records were obtained in the same way as those of system 3 except that the substrates were heated at 190° C. for 10 minutes.

### System 6

Records were obtained in the same way as those of system 3 except that the substrates were heated at 160° C. for 10 minutes.

### System 7

Records were obtained in the same way as those of system 3 except that the substrates were heated at 190° C. for 70 minutes.

### System 8

Records were obtained in the same way as those of system 3 except that the substrates were heated at 160° C. for 80 minutes.

### System 9

Records were obtained in the same way as those of system 3 except that the substrates were heated at 190° C. for 4 minutes.

### System 10

Records were obtained in the same way as those of System 3 except that the substrates were heated at 230° C. for 20 minutes.

### Evaluation Items

The records of systems 1 to 6, or more specifically package or semiconductor substrates having a coating of ink formed thereon, were subjected to the following evaluations (adhesiveness, rubfastness, and alcohol resistance) at room temperature.

### Adhesiveness

In accordance with JIS K 5600-5-6 (ISO 2409), Testing methods for paints—Part 5: Mechanical property of film—Section 6: Adhesion test (Cross-cut test), the solid images formed on substrates 1 to 4 were evaluated for adhesiveness to the substrate. The following describes the cross-cut test used here.

The tools used were a single-bladed cutting tool (a commercially available box cutter) and a guiding edge for correctly spacing the cuts of the single-bladed cutting tool.

First, the cutting tool was held with its blade normal to the coating under test, and 6 cuts were made on the record. After these 6 cuts were made, another 6 were made, crossing the original cuts at 90° to them.

Subsequently, from transparent adhesive tape (25±1 mm wide) a piece approximately 75 mm long was drawn and cut. This piece of tape was applied to the lattice cuts made on the coating, and then rubbed with a finger until the coating could be seen through the tape. Within 5 minutes after the tape was applied, the tape was pulled off steadily in 0.5 to 1.0 second at an angle close to 60°.

The evaluation criteria were as follows. Of these grades ⊙ and ◯ are practically acceptable. Evaluation results are summarized in Tables 3 and 4.

⊙: None of the squares of the lattice is detached.

◯: Some of the squares (<50%) of the lattice are detached.

Δ: 50% or more of the squares of the lattice are detached.

x: Substantially all squares of the lattice are detached.

### Rubfastness

A variable normal load friction and wear measurement system (TRIBOGEAR TYPE:HHS2000 [trade name], manufactured by Shinto Scientific Co., Ltd.) was used to evaluate the degree of coating detachment. With the load set at 300 gf, each solid image was scratched with a 0.2-mm diameter sapphire needle, and the degree of detachment was evaluated.

The evaluation criteria were as follows. Of these grades ⊙ and ◯ are practically acceptable. Evaluation results are summarized in Tables 3 and 4.

⊙: The coating has no scratches, and there is no coating detachment.

◯: There are scratches on a portion of the coating, but no coating detachment is observed.

Δ: Some portion of the coating is damaged, and the coating is detached.

x: The entire surface of the coating is damaged, and the coating is detached.

### Alcohol Resistance

The obtained records were immersed in IPA solution for 15 minutes. They were removed from the solution, and the degree of detachment was evaluated under the same conditions as the above rubfastness test.

The evaluation criteria were as follows. Of these grades ⊙ and ◯ are practically acceptable. Evaluation results are summarized in Tables 3 and 4.

⊙: The coating has no scratches, and there is no coating detachment.

◯: There are scratches on a portion of the coating, but no coating detachment is observed.

Δ: Some portion of the coating is damaged, and the coating is detached.

x: The entire surface of the coating is damaged, and the coating is detached.

TABLE 3

| | | | | | | | | | | | Exam- |
|---|---|---|---|---|---|---|---|---|---|---|---|
| | | Example 1 | Example 2 | Example 3 | Example 4 | Example 5 | Example 6 | Example 7 | Example 8 | Example 9 | ple 10 |
| System 1 | Adhesiveness | X | X | X | X | X | X | X | X | X | X |
| | Rubfastness | X | X | X | X | X | X | X | X | X | X |
| | Alcohol resistance | X | X | X | X | X | X | X | X | X | X |
| System 2 | Adhesiveness | Δ | Δ | Δ | Δ | Δ | Δ | Δ | Δ | Δ | Δ |
| | Rubfastness | Δ | Δ | Δ | Δ | Δ | Δ | Δ | Δ | Δ | Δ |
| | Alcohol resistance | Δ | Δ | Δ | Δ | Δ | Δ | Δ | Δ | Δ | Δ |
| System 3 | Adhesiveness | ◯ | Δ | Δ | Δ | Δ | Δ | ◯ | Δ | Δ | Δ |
| | Rubfastness | Δ | Δ | ◯ | Δ | Δ | Δ | Δ | Δ | Δ | Δ |
| | Alcohol resistance | Δ | Δ | Δ | Δ | Δ | Δ | Δ | Δ | Δ | Δ |
| System 4 | Adhesiveness | ⊙ | ⊙ | ⊙ | ⊙ | ⊙ | ⊙ | ⊙ | ⊙ | ⊙ | ⊙ |
| | Rubfastness | ⊙ | ⊙ | ⊙ | ⊙ | ⊙ | ⊙ | ⊙ | ⊙ | ⊙ | ⊙ |
| | Alcohol resistance | ⊙ | ⊙ | ⊙ | ⊙ | ⊙ | ⊙ | ⊙ | ⊙ | ⊙ | ⊙ |
| System 5 | Adhesiveness | ⊙ | ⊙ | ⊙ | ⊙ | ⊙ | ⊙ | ⊙ | ⊙ | ⊙ | ⊙ |
| | Rubfastness | ⊙ | ⊙ | ⊙ | ⊙ | ⊙ | ⊙ | ⊙ | ⊙ | ⊙ | ⊙ |
| | Alcohol resistance | ⊙ | ⊙ | ⊙ | ⊙ | ⊙ | ⊙ | ⊙ | ⊙ | ⊙ | ⊙ |
| System 6 | Adhesiveness | ⊙ | ⊙ | ⊙ | ⊙ | ⊙ | ⊙ | ⊙ | ⊙ | ⊙ | ⊙ |
| | Rubfastness | ⊙ | ⊙ | ⊙ | ⊙ | ⊙ | ⊙ | ⊙ | ⊙ | ⊙ | ⊙ |
| | Alcohol resistance | ⊙ | ⊙ | ⊙ | ⊙ | ⊙ | ⊙ | ⊙ | ⊙ | ⊙ | ⊙ |
| System 7 | Adhesiveness | ⊙ | ⊙ | ⊙ | ⊙ | ⊙ | ⊙ | ⊙ | ⊙ | ⊙ | ⊙ |
| | Rubfastness | ⊙ | ⊙ | ⊙ | ⊙ | ⊙ | ⊙ | ⊙ | ⊙ | ⊙ | ⊙ |
| | Alcohol resistance | ⊙ | ⊙ | ⊙ | ⊙ | ⊙ | ⊙ | ⊙ | ⊙ | ⊙ | ⊙ |
| System 8 | Adhesiveness | ◯ | ◯ | ◯ | ◯ | ◯ | ◯ | ◯ | ◯ | ◯ | ◯ |
| | Rubfastness | ◯ | ◯ | ◯ | ◯ | ◯ | ◯ | ◯ | ◯ | ◯ | ◯ |
| | Alcohol resistance | ◯ | ◯ | ◯ | ◯ | ◯ | ◯ | ◯ | ◯ | ◯ | ◯ |
| System 9 | Adhesiveness | ◯ | ◯ | ◯ | ◯ | ◯ | ◯ | ◯ | ◯ | ◯ | ◯ |
| | Rubfastness | ◯ | ◯ | ◯ | ◯ | ◯ | ◯ | ◯ | ◯ | ◯ | ◯ |
| | Alcohol resistance | ◯ | ◯ | ◯ | ◯ | ◯ | ◯ | ◯ | ◯ | ◯ | ◯ |
| System 10 | Adhesiveness | X | X | X | X | X | X | X | X | X | X |
| | Rubfastness | X | X | X | X | X | X | X | X | X | X |
| | Alcohol resistance | X | X | X | X | X | X | X | X | X | X |

| | | Example | Example | Example | Example | Example | Example | Example |
|---|---|---|---|---|---|---|---|---|
| | | 11 | 12 | 13 | 14 | 15 | 16 | 17 |
| System 1 | Adhesiveness | X | X | X | X | X | X | X |
| | Rubfastness | X | X | X | X | X | X | X |
| | Alcohol resistance | X | X | X | X | X | X | X |
| System 2 | Adhesiveness | Δ | Δ | Δ | Δ | Δ | Δ | Δ |
| | Rubfastness | Δ | Δ | Δ | Δ | Δ | Δ | Δ |
| | Alcohol resistance | Δ | Δ | Δ | Δ | Δ | Δ | Δ |
| System 3 | Adhesiveness | Δ | ◯ | ◯ | ◯ | Δ | Δ | Δ |
| | Rubfastness | Δ | Δ | Δ | Δ | Δ | Δ | Δ |
| | Alcohol resistance | Δ | Δ | Δ | Δ | Δ | Δ | Δ |
| System 4 | Adhesiveness | ⊙ | ⊙ | ⊙ | ⊙ | ◯ | ◯ | ◯ |
| | Rubfastness | ⊙ | ⊙ | ⊙ | ⊙ | ◯ | ◯ | ◯ |
| | Alcohol resistance | ⊙ | ⊙ | ⊙ | ⊙ | ◯ | ◯ | ◯ |
| System 5 | Adhesiveness | ⊙ | ⊙ | ⊙ | ⊙ | ◯ | ◯ | ◯ |
| | Rubfastness | ⊙ | ⊙ | ⊙ | ⊙ | ◯ | ◯ | ◯ |
| | Alcohol resistance | ⊙ | ⊙ | ⊙ | ⊙ | ◯ | ◯ | ◯ |
| System 6 | Adhesiveness | ⊙ | ⊙ | ⊙ | ⊙ | ◯ | ◯ | ◯ |
| | Rubfastness | ⊙ | ⊙ | ⊙ | ⊙ | ◯ | ◯ | ◯ |
| | Alcohol resistance | ⊙ | ⊙ | ⊙ | ⊙ | ◯ | ◯ | ◯ |
| System 7 | Adhesiveness | ⊙ | ⊙ | ⊙ | ⊙ | ◯ | ◯ | ◯ |
| | Rubfastness | ⊙ | ⊙ | ⊙ | ⊙ | ◯ | ◯ | ◯ |
| | Alcohol resistance | ⊙ | ⊙ | ⊙ | ⊙ | ◯ | ◯ | ◯ |
| System 8 | Adhesiveness | ◯ | ◯ | ◯ | ◯ | Δ | Δ | Δ |
| | Rubfastness | ◯ | ◯ | ◯ | ◯ | ◯ | ◯ | ◯ |
| | Alcohol resistance | ◯ | ◯ | ◯ | ◯ | ◯ | ◯ | ◯ |
| System 9 | Adhesiveness | ◯ | ◯ | ◯ | ◯ | Δ | Δ | Δ |
| | Rubfastness | ◯ | ◯ | ◯ | ◯ | ◯ | ◯ | ◯ |
| | Alcohol resistance | ◯ | ◯ | ◯ | ◯ | ◯ | ◯ | ◯ |
| System 10 | Adhesiveness | X | X | X | X | X | X | X |
| | Rubfastness | X | X | X | X | X | X | X |
| | Alcohol resistance | X | X | X | X | X | X | X |

TABLE 4

| | | Compara- | Compara- | Compara- | Compara- |
|---|---|---|---|---|---|
| | | tive Ex- | tive Ex- | tive Ex- | tive Ex- |
| | | ample 1 | ample 2 | ample 3 | ample 4 |
| System | Adhesiveness | x | x | x | x |
| 1 | Rubfastness | x | x | x | x |
| | Alcohol | x | x | x | x |
| | resistance | | | | |
| System | Adhesiveness | Δ | x | x | x |
| 2 | Rubfastness | Δ | x | x | x |
| | Alcohol | Δ | x | x | x |
| | resistance | | | | |
| System | Adhesiveness | Δ | x | x | x |
| 3 | Rubfastness | Δ | x | x | x |
| | Alcohol | Δ | x | x | x |
| | resistance | | | | |
| System | Adhesiveness | Δ | Δ | Δ | Δ |
| 4 | Rubfastness | ∘ | Δ | Δ | Δ |
| | Alcohol | Δ | Δ | Δ | Δ |
| | resistance | | | | |
| System | Adhesiveness | Δ | Δ | Δ | Δ |
| 5 | Rubfastness | ∘ | Δ | Δ | Δ |
| | Alcohol | Δ | Δ | Δ | Δ |
| | resistance | | | | |
| System | Adhesiveness | Δ | Δ | Δ | Δ |
| 6 | Rubfastness | ∘ | Δ | Δ | Δ |
| | Alcohol | Δ | Δ | Δ | Δ |
| | resistance | | | | |
| System | Adhesiveness | Δ | Δ | Δ | Δ |
| 7 | Rubfastness | ∘ | Δ | Δ | Δ |
| | Alcohol | Δ | Δ | Δ | Δ |
| | resistance | | | | |
| System | Adhesiveness | Δ | Δ | Δ | Δ |
| 8 | Rubfastness | Δ | Δ | Δ | Δ |
| | Alcohol | Δ | Δ | Δ | Δ |
| | resistance | | | | |
| System | Adhesiveness | Δ | Δ | Δ | Δ |
| 9 | Rubfastness | Δ | Δ | Δ | Δ |
| | Alcohol | Δ | Δ | Δ | Δ |
| | resistance | | | | |
| System | Adhesiveness | x | x | x | x |
| 10 | Rubfastness | x | x | x | x |
| | Alcohol | x | x | x | x |
| | resistance | | | | |

As can be seen from Tables 3 and 4, radiation-curable inks for ink jet recording that contain 5% by mass to 20% by mass, inclusive, of N-vinylcaprolactam are excellent in all of rubfastness, adhesiveness, and alcohol resistance when applied to a package substrate or a semiconductor substrate, exposed to radiation, and heated at a temperature in a range of 150° C. to 200° C., inclusive.

The following details the second aspect of the invention with reference to its examples; however, this aspect is not limited to these examples.

### Raw Materials

In the examples and comparative examples below, the following raw materials were used.

### Polymerizable Compounds

N-vinylcaprolactam (manufactured by BASF; “NVC” in Table 5)
Viscoat #192 (phenoxyethyl acrylate, a trade name of OSAKA ORGANIC CHEMICAL INDUSTRY LTD.; “PEA” in Table 5)
PET3A (pentaerythritol triacrylate, a trade name of OSAKA ORGANIC CHEMICAL INDUSTRY LTD.)
PETA-K (pentaerythritol tetraacrylate, a trade name of DAICEL-CYTEC Co., Ltd.)
IBXA (isobornyl acrylate, a trade name of OSAKA ORGANIC CHEMICAL INDUSTRY LTD.)

### Photopolymerization Initiators

IRGACURE 819 (100% solids bis(2,4,6-trimethylbenzoyl)phenylphosphine oxide, a trade name of BASF; “819” in Table 5)
DAROCURE TPO (100% solids 2,4,6-trimethylbenzoyldiphenylphosphine oxide, a trade name of BASF; “TPO” in Table 5)

### Slipping Agent

Silicone surface conditioner BYK-UV3500 (a polydimethylsiloxane having a polyether-modified acryl group, a trade name of BYK; “UV3500” in Table 5)

### Polymerization Inhibitor

p-Methoxyphenol (manufactured by KANTO CHEMICAL Co., INC.; “MEHQ” in Table 5)

### Pigment

R-630 (titanium oxide, a trade name of ISHIHARA SANGYO KAISHA, LTD.; “TiO₂” in Table 5)

### Dispersant

Solsperse 36000 (a trade name of LUBRIZOL; “Sol 36000” in Table 5)

### Substrates

Substrate 1 (package substrate): Epoxy resin surface 1 (surface-mount package P-LFBGA048-0606, manufactured by Sharp Corporation)
Substrate 2 (package substrate): Epoxy resin surface (serial EEPROM BR24L01A, manufactured by ROHM Co., Ltd.)
Substrate 3 (semiconductor substrate): Silicon surface 1 (a 300-mm silicon wafer, manufactured by Shin-Etsu Chemical Co., Ltd.)
Substrate 4 (semiconductor substrate): Silicon surface 2 (an SOI wafer, manufactured by SUMCO Corporation)

Substrates 3 and 4 were used after circuits were formed on the wafer and the wafer was diced into semiconductor chips. Each wafer was coated with a silicon oxide film having a thickness of 50 nm during the circuit formation.

### Examples 1 to 11 and Comparative Examples 1 to 6

### Preparation of Radiation-Curable Inks for Ink Jet Recording

The ingredients listed in Table 5 were blended in accordance with the proportions (unit of measurement: % by mass) specified in Table 5, and the mixtures were stirred at room temperature for 1 hour and thereby complete dissolution was achieved. The obtained solutions were each filtered through a 5 μm membrane filter. In this way, radiation-curable inks for ink jet recording were obtained.

TABLE 5

| | | Exam- | Exam- | Exam- | Exam- | Exam- | Exam- | Exam- | Exam- | Exam- | Exam- | Example |
|---|---|---|---|---|---|---|---|---|---|---|---|---|
| | | ple 1 | ple 2 | ple 3 | ple 4 | ple 5 | ple 6 | ple 7 | ple 8 | ple 9 | ple 10 | 11 |
| Polymerizable compounds | NVC | 10.0 | 12.0 | 5.0 | 20.0 | 13.6 | 16.0 | 15.0 | 15.0 | 5.0 | 5.0 | 5.0 |
| | PEA | 48.6 | 41.6 | 50.0 | 39.6 | 50.0 | 32.6 | 43.6 | — | 50.0 | 50.0 | 50.0 |
| | PET3A | 10.0 | 15.0 | 13.6 | 9.0 | 5.0 | 20.0 | — | 18.0 | 13.6 | 13.6 | 13.6 |
| | PETA-K | — | — | — | — | — | — | 10.0 | — | — | — | — |
| | IBXA | — | — | — | — | — | — | — | 35.6 | — | — | — |
| Photopolymerization initiators | 819 | 4.0 | 4.0 | 4.0 | 4.0 | 4.0 | 4.0 | 4.0 | 4.0 | 4.0 | 4.0 | 4.0 |
| | TPO | 5.0 | 5.0 | 5.0 | 5.0 | 5.0 | 5.0 | 5.0 | 5.0 | 5.0 | 5.0 | 5.0 |
| Slipping agent | UV 3500 | 0.2 | 0.2 | 0.2 | 0.2 | 0.2 | 0.2 | 0.2 | 0.2 | 0.2 | 0.2 | 0.2 |
| Polymerization inhibitor | MEHQ | 0.2 | 0.2 | 0.2 | 0.2 | 0.2 | 0.2 | 0.2 | 0.2 | 0.2 | 0.2 | 0.2 |
| Pigment | TiO₂ | 20.0 | 20.0 | 20.0 | 20.0 | 20.0 | 20.0 | 20.0 | 20.0 | 20.0 | 20.0 | 20.0 |
| Dispersant | Sol 36000 | 2.0 | 2.0 | 2.0 | 2.0 | 2.0 | 2.0 | 2.0 | 2.0 | 2.0 | 2.0 | 2.0 |

| | | | | | | | | | | | |
|---|---|---|---|---|---|---|---|---|---|---|---|
| Total | 100.0 | 100.0 | 100.0 | 100.0 | 100.0 | 100.0 | 100.0 | 100.0 | 100.0 | 100.0 | 100.0 |
| Substrate No. | 1 | 1 | 1 | 1 | 1 | 1 | 1 | 1 | 2 | 3 | 4 |
| Curability | ⊙ | ⊙ | ⊙ | ⊙ | ⊙ | ⊙ | ⊙ | ◯ | ⊙ | ⊙ | ⊙ |
| Adhesiveness | ⊙ | ⊙ | ⊙ | ⊙ | ⊙ | ⊙ | ⊙ | ◯ | ⊙ | ⊙ | ⊙ |
| Rubfastness | ⊙ | ⊙ | ⊙ | ⊙ | ⊙ | ⊙ | ⊙ | ◯ | ⊙ | ⊙ | ⊙ |
| Alcohol resistance | ⊙ | ⊙ | ⊙ | ⊙ | ⊙ | ⊙ | ⊙ | ◯ | ⊙ | ⊙ | ⊙ |

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| Polymerizable | NVC | 10.0 | 28.0 | 23.0 | 12.0 | 3.0 | 24.0 | 3.0 | 26.0 |
| compounds | PEA | 33.6 | 15.1 | 42.6 | 54.6 | 63.1 | — | 47.6 | 29.6 |
| | PET3A | 25.0 | 25.5 | 3.0 | 2.0 | — | 29.6 | 18.0 | 13.0 |
| | PETA-K | — | — | — | — | 2.5 | — | — | — |
| | IBXA | — | — | — | — | — | 15.0 | — | — |
| Photopolymerization | 819 | 4.0 | 4.0 | 4.0 | 4.0 | 4.0 | 4.0 | 4.0 | 4.0 |
| initiators | TPO | 5.0 | 5.0 | 5.0 | 5.0 | 5.0 | 5.0 | 5.0 | 5.0 |
| Slipping agent | UV 3500 | 0.2 | 0.2 | 0.2 | 0.2 | 0.2 | 0.2 | 0.2 | 0.2 |
| Polymerization | MEHQ | 0.2 | 0.2 | 0.2 | 0.2 | 0.2 | 0.2 | 0.2 | 0.2 |
| inhibitor | | | | | | | | | |
| Pigment | TiO₂ | 20.0 | 20.0 | 20.0 | 20.0 | 20.0 | 20.0 | 20.0 | 20.0 |
| Dispersant | Sol 36000 | 2.0 | 2.0 | 2.0 | 2.0 | 2.0 | 2.0 | 2.0 | 2.0 |

| | | | | | | | | |
|---|---|---|---|---|---|---|---|---|
| Total | 100.0 | 100.0 | 100.0 | 100.0 | 100.0 | 100.0 | 100.0 | 100.0 |
| Substrate No. | 1 | 1 | 1 | 1 | 1 | 1 | 1 | 1 |
| Curability | ⊙ | ⊙ | ⊙ | ⊙ | ◯ | ◯ | ⊙ | ⊙ |
| Adhesiveness | Δ | Δ | Δ | Δ | Δ | X | Δ | Δ |
| Rubfastness | Δ | Δ | Δ | Δ | Δ | X | Δ | Δ |
| Alcohol resistance | Δ | Δ | Δ | Δ | Δ | X | Δ | Δ |

### Preparation of Ink Coatings

Substrates 1 to 4 were each pretreated by exposure to light from a low-pressure mercury lamp. In accordance with the combinations of inks and substrates given in Table 5, a solid image was printed on the pretreated substrates using an ink jet printer (PX-75505 [trade name], manufactured by Seiko Epson Corporation). The thickness of the print (image) was set at 10 μm. The substrates were then exposed to radiation under the following conditions and thereby the ink was cured: wavelength: 395 nm; radiation intensity: 500 mW/cm²; maximum irradiation: 600 mJ/cm². In this way, records were obtained. The solid image has the same meaning as defined in the description of examples of the first aspect of the invention.

### Evaluation Items

The obtained records, or more specifically package or semiconductor substrates having a coating of ink formed thereon, were subjected to the following evaluations (curability, adhesiveness, rubfastness, and alcohol resistance) at room temperature.

### Curability

Each ink was applied to substrate 1 to form a solid image, cured by exposure to radiation, and evaluated for tackiness by a finger-touch test.

The wavelength of the radiation was 395 nm, and the radiation intensity was 500 mW/cm². Evaluations were made by calculating the energy of the UV radiation required to cure the ink. The energy of radiation [mJ/cm²] was calculated as the product of the radiation intensity [mW/cm²] of the light source measured on the exposed surface and the duration of exposure [seconds]. The radiation intensity was measured using UV radiometer UM-10 and receptor head UM-400 (both manufactured by Konica MINOLTA SENSING, INC.).

The evaluation criteria were as follows.

⊙: <300 mJ/cm^{2 ◯:} 300 mJ/cm² to <500 mJ/cm² x: ≧500 mJ/cm²

### Adhesiveness

In accordance with JIS K 5600-5-6 (ISO 2409), Testing methods for paints—Part 5: Mechanical property of film—Section 6: Adhesion test (Cross-cut test), the solid images formed on substrates 1 to 4 were evaluated for adhesiveness to the substrate. The cross-cut test used here was the same as that performed for the examples and comparative examples of the first aspect of the invention.

The evaluation criteria were as follows. Of these grades ⊙ and ◯ are practically acceptable.

⊙: None of the squares of the lattice is detached.

◯: Some of the squares (<50%) of the lattice are detached.

Δ: 50% or more of the squares of the lattice are detached.

x: Substantially all squares of the lattice are detached.

### Rubfastness

A variable normal load friction and wear measurement system (TRIBOGEAR TYPE:HHS2000 [trade name], manufactured by Shinto Scientific Co., Ltd.) was used to evaluate the degree of coating detachment. With the load set at 300 gf, each solid image was scratched with a 0.2-mm diameter sapphire needle, and the degree of detachment was evaluated.

The evaluation criteria were as follows. Of these grades ⊙ and ◯ are practically acceptable.

⊙: The coating has no scratches, and there is no coating detachment.

◯: There are scratches on a portion of the coating, but no coating detachment is observed.

Δ: Some portion of the coating is damaged, and the coating is detached.

x: The entire surface of the coating is damaged, and the coating is detached.

### Alcohol Resistance

The obtained records were immersed in IPA solution for 15 minutes. They were removed from the solution, and the degree of detachment was evaluated under the same conditions as the above rubfastness test.

The evaluation criteria were as follows. Of these grades ⊙ and ◯ are practically acceptable.

⊙: The coating has no scratches, and there is no coating detachment.

◯: There are scratches on a portion of the coating, but no coating detachment is observed.

Δ: Some portion of the coating is damaged, and the coating is detached.

x: The entire surface of the coating is damaged, and the coating is detached.

As can be seen from Table 5, radiation-curable inks for ink jet recording containing N-vinylcaprolactam and a polyfunctional (meth)acrylate having a pentaerythritol structure in amounts in a particular range (examples of the second aspect of the invention) have better adhesiveness, rubfastness, and alcohol resistance than those containing the compounds in amounts out of the particular range (comparative examples).

1-12. (canceled)

13. An ink jet recording method comprising:
ejecting a radiation-curable ink for ink jet recording onto a recording medium, the radiation-curable ink comprising an amount of N-vinylcaprolactam relative to a total mass of the ink that is greater than zero and less than 10% by mass, and 5% by mass to 20% by mass of a polyfunctional (meth)acrylate relative to the total mass of the ink; and
curing the ejected radiation-curable ink to provide a cured ink by exposing the ejected radiation-curable ink to an active radiation having an emission peak wavelength in a range of 350 nm to 400 nm.

14. The ink jet recording method according to claim 13, wherein the amount of the N-vinylcaprolactam relative to the total mass of the ink is 5% by mass to 10% by mass.

15. The ink jet recording method according to claim 13, wherein the polyfunctional (meth)acrylate has a pentaerythritol structure.

16. The ink jet recording method according to claim 13, wherein the recording medium comprises a package substrate or a semiconductor substrate.

17. The ink jet recording method according to claim 16, wherein the package substrate or the semiconductor substrate includes a marking comprising the cured ink.

18. The ink jet recording method according to claim 13, further comprising heating the cured ink at a temperature in a range of 150° C. to 200° C.

19. The ink jet recording method according to claim 18, wherein the heating comprises heating the recording medium comprising a package substrate or a semiconductor substrate.
